(19) United States
(12) Patent Application Publication
(10) Pub. No.: US 2010/0031757 A1
(43) Pub. Date: Feb. 11, 2010

(54) SAMPLE HANDLING DEVICE FOR AND A METHOD OF HANDLING A SAMPLE

(75) Inventor: Olaf Hoyer, Jena (DE)

Correspondence Address: KNOBBE MARTENS OLSON & BEAR LLP, 2040 MAIN STREET, FOURTEENTH FLOOR, IRVINE, CA, 92614, US

(73) Assignee: QUANTIFOIL INSTRUMENTS GMBH, JENA (DE)

(21) Appl. No.: 12/298,508

(22) PCT Filed: Apr. 26, 2007
(86) PCT No.: PCT/EP07/54112

§ 371 Date: Aug. 5, 2009

Related U.S. Application Data
(60) Provisional application No. 60/795,099, filed on Apr. 26, 2006.
(60) Provisional application No. 60/806,571, filed on Jul. 5, 2006.

(30) Foreign Application Priority Data
Jul. 5, 2006 (EP) 06116645.0

(51) Int. Cl. G01N 1/31

(52) U.S. Cl. 73/863.01

(57) ABSTRACT

A sample handling device (100) for handling a sample, the sample handling device (100) comprising a base part (101), a cover part (102), a first force generating unit (104, 105) adapted to generate an attracting force promoting attraction between the base part (101) and the cover part (102), a second force generating unit (108, 142) adapted to generate a counterforce having at least a component being oriented opposite to the attracting force to promote a motion of the base part (101) and the cover part (102) relative to each other, and a control unit (103) adapted for controlling the second force generating unit (108, 142) for moving the base part (101) and the cover part (102) relative to each other for influencing a sample space (130) between the base part (101) and the cover part (102) for accommodating the sample.

This application claims the benefit of the filing date of European Patent Application No. 06116645.0 filed Jul. 5, 2006, of U.S. Provisional Patent Application No. 60/806,571 filed Jul. 5, 2006, and of U.S. Provisional Patent Application No. 60/795,099 filed Apr. 26, 2006, the disclosure of which is hereby incorporated herein by reference.

### FIELD OF THE INVENTION

The invention relates to a sample handling device for handling a sample.

Moreover, the invention relates to a module for a sample handling device.

The invention further relates to a method of handling a sample.

Moreover, the invention relates to a program element.

Further, the invention relates to a computer-readable medium.

Beyond this, the invention relates to an insert element.

### BACKGROUND OF THE INVENTION

Biochemical analysis systems for supplying, handling, and analyzing samples are important in the field of life science.

WO 2001/51909 discloses specimen slide preparation using slide trays that have receptacles for at least one specimen slide and an associated reagent park. The specimen slide and/or reagent pack includes an identifier that specifies a particular slide preparation protocol that should be followed. The system reads the identifier to determine the particular slide preparation protocol and then prepares the specimen slide according to the particular slide preparation protocol. The apparatus may obtain some or all of the reagents needed for the particular slide preparation protocol from the reagent pack.

DE 102 18 988 discloses moistening objects with a liquid, comprising a device for supporting an object carrier which is arranged at a distance from a platform. In order to reduce the amount of required liquid, the object carrier is raised and lowered in relation to the platform by means of a device.

DE 103 52 716 discloses a platform for a device for wetting objects, especially for an incubation/hybridization chamber that is defined by an object support and the platform arranged at a distance to said object support. Said platform comprises a base provided with at least one spacer and a frame carrying said base. The base of the platform is movably mounted relative to the frame by means of a bearing device. Said bearing device, in a first functional position, maintains the base in such a manner that it projects from the frame and/or the bearing device, and in a second functional position it projects in some areas beyond an imaginary plane in which the surface of the base is disposed.

However, operation of such devices may be time consuming in a scenario in which large numbers of samples shall be analyzed, for instance for high-throughput screening.

### OBJECT AND SUMMARY OF THE INVENTION

It is an object of the invention to enable an efficient handling of a sample.

In order to achieve the object defined above, a sample handling device for handling a sample, a module for a sample handling device, a method of handling a sample, a program element, a computer-readable medium, and an insert element according to the independent claims are provided.

According to an exemplary embodiment of the invention, a sample handling device for handling a sample is provided, the sample handling device comprising a base part, a cover part, a first force generating unit adapted to generate a force between the base part and the cover part, a second force generating unit adapted to generate a counterforce having at least a component being oriented opposite to the force to promote moving of the base part and the cover part relative to each other, and a control unit adapted for controlling the second force generating unit for moving the base part and the cover part relative to each other for influencing a sample space between the base part and the cover part for accommodating the sample.

According to another exemplary embodiment of the invention, a (for instance autarkically operable) module for insertion into a reception of a housing of a sample handling device is provided, the module comprising a base part, a cover part, a first force generating unit adapted to generate a force between the base part and the cover part, and a second force generating unit adapted to generate a counterforce having at least a component being oriented opposite to the force to promote a motion of the base part and the cover part relative to each other, wherein the second force generating unit is controllable by a control unit (which may be provided internally as a component of the module, or which may be provided externally as a component of a sample handling device in which the module is insertable) for moving the base part and the cover part relative to each other for influencing a sample space between the base part and the cover part for accommodating the sample.

According to another exemplary embodiment of the invention, a method of handling a sample is provided, the method comprising generating a force between a base part and a cover part, generating a counterforce having at least a component being oriented opposite to the force to promote moving of the base part and the cover part relative to each other, and controlling the counterforce for moving the base part and the cover part relative to each other for influencing a sample space between the base part and the cover part for accommodating the sample.

According to still another exemplary embodiment of the invention, a program element is provided, which, when being executed by a processor, is adapted to control or carry out a method of handling a sample having the above mentioned features.

According to yet another exemplary embodiment of the invention, a computer-readable medium is provided, in which a computer program is stored which, when being executed by a processor, is adapted to control or carry out a method of handling a sample having the above mentioned features.

The control of the sampling scheme according to embodiments of the invention can be realized by a computer program, that is by software, or by using one or more special electronic optimization circuits, that is in hardware, or in hybrid form, that is by means of software components and hardware components.

According to still another exemplary embodiment of the invention, an insert element for insertion into a cover part of a sample handling device for handling a sample is provided, the sample handling device comprising the cover part and a base part for enclosing a sample space for accommodating the sample, wherein the insert element comprises an essentially planar central plate defining part of the sample space, and a flexible seal ring surrounding the essentially planar central plate and biased for sealing the sample space. Such an embodiment may build up on devices as disclosed in DE 102 18 988 and DE 103 52 716 which are incorporated in their entirety in the disclosure of this patent application, in particular the devices disclosed in the figures and corresponding description of DE 102 18 988 and DE 103 52 716.

The term “sample” may particularly denote any solid, liquid or gaseous substance, or a combination thereof. For instance, the sample may be a fluidic sample, furthermore particularly a biological substance. Such a substance may comprise proteins, polypeptides, nucleic acids, DNA strands, etc.

The term “sample space” may particularly denote any (constant or variable) volume which may be delimited by components of the sample handling device and within which the sample may be accommodated in a fixed or movable manner.

The term “force generating unit” may denote any physical or non-physical mechanism which results in any attractive or repulsive force acting on one or both of the base part and the cover part. Exemplary force generating mechanisms are magnetic forces, electric forces, mechanic forces, gravitational forces, overpressure or negative pressure forces, impulses etc.

The term “counterforce” may denote any force which has another vector direction than the (other) force, particularly any force which has a vector component which is oriented essentially antiparallel to the (other) force, more particularly any force which is oriented essentially antiparallel to the (other) force.

According to an exemplary embodiment, an apparatus, particularly for applications in the field of life science, may be provided in which a base part and a cover part may be tilted with respect to one another under the influence of two different forces, thereby allowing to modify the volume of a sample space enclosed between the base part and the cover part. Consequently, capillary forces and other interactions may be varied, since such capillary forces are usually more effective or relevant in case of a small angle between base part and cover part as compared to a scenario in which the angle between base part and cover part is larger. Therefore, (fluidic) sample material can be transported into or out of the sample space using capillary forces and other interactions, allowing to automate sample supply and sample draining/carrying off. This may allow to use the sample handling device particularly for high throughput screening applications without the need that a human user has to spend a lot of operating time for operating the device, and many samples can be tested with such an automated sample handling system in a short time.

A first (particular) attracting force may be generated between the base part and the cover part, for instance using magnetic elements located in the base part and in the cover part and having opposite magnetic polarity. Counteracting to this attracting magnetic force, a variable counterforce (for instance a mechanical, magnetic, or electric counterforce) may be selectively modified under the control of a control unit (like a computer, a microprocessor, or a CPU) so that the base part and the cover part approach each other when the attracting force is larger than the repulsive force, and move away from each other when the counterforce is larger than the attractive force.

For example, such a sample handling device may allow to handle a sample in an automatic manner, for instance with a pneumatic mechanism for automatically supplying the sample. Such a pneumatic mechanism may generate the repulsive force using a pneumatically driven piston acting on the cover part, thereby automating operation of the sample handling device. Such a pneumatically driven piston may act on the base part and/or on the cover part to increase the distance between these two components when being extended, or to decrease the distance between these two components when being retracted.

In other words, two plate-like elements foreseen with a variable angle with respect to one another may be opened and closed to increase or decrease capillary forces. A tube at an inlet opening provided at the base part and/or at the cover part may allow to inject or suck off a fluidic sample. A simple mechanic tilting motion performed between the base part and the cover part may allow to handle the sample. Optionally, a further opening may be provided at the base part and/or at the cover part in order to supply a cleaning fluid for cleaning the sample chamber between two subsequent sample analysis cycles.

At least a part of the sample handling device may be operated by a robot which may take care of supplying samples, rinsing, substituting components of the sample handling device (like a sample carrier or a frame to be inserted in the base part), etc.

For instance, a solid tissue sample may be positioned on a carrier plate (for instance a glass plate). Then, a fluidic sample to react with the tissue sample may be supplied between the base part and the cover part so as to examine the tissue sample in the presence of the fluidic sample.

It is possible to integrate a detection unit in the sample handling device capable of detecting whether any interaction has occurred between sample supplied to the sample space and an object under examination provided between the base part and the cover part. Such a detection unit may be an optical detection unit, an electric detection unit, or any other biochemical detection unit.

A bar code or any other indicia may be foreseen on a sample carrier allowing to be positioned on the base part to later identify which sample has been tested on this sample carrier, in a multi experiment application. However, the carrier element may also be a micro array, for instance having a matrix-like arrangement of different test substances (like DNA strands) bound thereon.

According to an exemplary embodiment, a volume of a reaction chamber may be modified by tilting an upper and a lower component thereof (and/or lateral components thereof) so that capillary forces may allow to supply a sample or to remove a sample from the reaction chamber. However, also a parallel motion of base part and cover part relative to each other is possible for modulating the volume of the sample space.

The sample handling device according to an exemplary embodiment may be capable to perform high temperature experiments (for instance to perform experiments at temperatures of 95° C. or more), for instance by providing a temperature control unit which may be advantageously integrated in the base part and which may be capable to heat or cool the sample during the analysis in an adjustable manner.

In order to securely seal the sample space, an insert element (which may or may not be inserted in a frame or which may be insertable directly in the cover part) may be inserted in the cover part and may provides a spring-like mechanical biasing force so as to press the insert element onto the carrier element located on the base part, thereby ensuring that the fluidic sample is in fact restricted to the sample space. This may be achieved by a flexible rubber seal (some kind of O-ring) which may be provided between a planar contact surface and a surrounding connection ring of the insert element. Spacers in the form of protrusions or pins (for instance with a vertical size of 50 μm) may be provided on such a contacting surface so as to guarantee a volume in which the fluidic sample may be located.

As already mentioned, the insert element may be connected to the cover part via a frame, or may be directly inserted into the cover part, for example by an engagement mechanism like snap-in protrusions provided at the cover part and/or at the insert element.

When using a separate frame in which the insert element is inserted for connecting the frame with the insert element inserted therein to the cover part, corresponding magnetic elements may be provided in the frame and in the cover part. This may simplify insertion, since a guiding magnetic force may assist a human operator during inserting the frame into the cover part.

The cover part or the insert element may have a sample insertion opening for inserting the sample from an exterior position into the sample space. When such a sample insertion opening is surrounded by a ring-shaped magnetic element, a correspondingly shaped and magnetically polarized magnetic pin for closing the opening may be provided. This may assist an operator to correctly insert the pin in a sealed manner into the insertion opening using the attracting magnetic forces between the ring-shaped magnetic element and the magnetically polarized magnetic pin.

Also the positioning between the cover part and the base part may be ensured by attracting magnetic forces resulting from magnetic elements provided in the cover part and in the base part.

It is also possible that the cover part when mounted on the base part may not only be tilted but may also be shifted along a certain longitudinal distance relative to the base part, wherein a mechanism may be provided which correlates tilting with shifting. This may allow to provide an opening in the cover part which only allows access through this opening to the sample space in a certain tilting state and corresponding shifting state between base part and cover part, wherein access may be prevented in another tilting and sliding state of base part and cover part. This may allow a human user or a robot to get access to the sample space only when the base part and the cover part are sufficiently far away from one another, and simultaneously allows to securely seal the sample space between base part and cover part when they are close together.

The minimum distance between base part and cover part may be ensured by a screw mechanism or any other spacer. For instance, a screw may be screwed through a thread provided in the cover part to abut with a certain distance onto a surface of the base part, thereby defining a minimum distance between the base part and the cover part, adjustable by screwing the screw.

When such a screw mechanism maintains only a very small distance between the base part and the cover part, magnets may be provided in the base part and the cover part for sealing the sample space, when the screw is closed.

The cover part may be mounted in a manner to float on the base part, due to magnetic forces. A flexible sealing ring may generate a biasing force to maintain the floating state.

A visible inspection slit or other opening may be provided in the cover part. This allows a human operator to control the sample when being located within the sample space.

A (single or multiple) cross pattern or any other arrangement of braces or shores may be formed in the insert element for example at a surface opposing the surface delimiting the sample space when being inserted into the cover part. Such a brace mechanism may increase the mechanical stability.

In contrast to this, the surface contacting the sample may be planar, optionally with the exception of rod-like or pin-like protrusions for instance of a size of 50 μm ensuring a minimum volume available for the sample. Such a configuration may be advantageous in manufacture and in operation.

As an alternative to a cross-like brace structure, a star-like structure may be formed, for instance with a central bump for proper mechanical stability.

Optionally, the cover part may be provided with an element which is mounted in a resilient manner using a spring mechanism. In such a scenario, the cover part may be provided with different magnetic elements having a repulsive force, and an insert element may float under this influence.

A sample supply opening may be provided on a top of the cover part or on the top of the insert element, or may be also provided laterally of the cover part and/or of the insert element. It may be advantageous to locate such an injection opening close to a tilting axis around which the cover part is tiltable with respect to the base part, thereby allowing accurate sample supply also during tilting.

A protrusion or any other element or alignment marker may be provided at the insert element and/or in the frame and/or in the cover part to allow a proper insertion of the insert element into the frame or into the cover part, respectively. This may allow to operate the device also without special skills, since an improper insertion may be prevented mechanically.

Insertion of carrier element/object under examination/insert element may be performed manually or can also be automated, for instance by implementing a robot. For example, different tissue samples may be positioned on a glass carrier and may be analyzed with one or more different samples brought into contact with the tissue sample. Supply of such fluidic samples, supply of the tissue sample and/or supply or substitution of glass plates and/or insert elements may be performed automatically.

Particularly, a combination between a magnetic attraction force and a pneumatic repulsive force may allow to construct a simple but very efficient system which allows to significantly reduce operation times, thereby increasing throughput.

A pneumatic piston may reciprocate, for instance in a vertical direction, and attracting magnetic forces between ground plate and upper plate may have the tendency of attracting these two components.

One aspect of the invention is directed to an apparatus in which a sample space is, by default, closed with an attractive force (or for instance 180 N to 200 N). However, with a counterforce, the sample space can be selectively opened. For this purpose, a cover part and a base part may be angularly beared in a tilting point or axis.

Opening and closing the space between cover part and base part may allow to transport the fluid to a desired position using capillary forces, but may also allow for mixing a fluidic sample with an object under investigation (for instance a tissue sample) provided in the sample space. For example, these two operation states may be realized with a pneumatic mechanism having two different stroke distances. A first stroke distance may be configured for opening and closing the cover part and the base part in order to transport the sample inside the sample space. In a second distance stroke of the distance which may be smaller than the first distance stroke, a mixing of the material which is already injected into the sample space may be enabled with a small amplitude oscillation between base part and cover part.

A button or any other user interface may be provided which may be operated by a user, for instance for confirming that the sample has been filled in the sample space. It may also be an emergency switch-off or a switch-on button.

A hole may be provided in the cover part so that the sample space may be exposed, for instance for a fluid supply by a robot. Pressure air may be supplied to the sample space in order to transport the sample out of the sample space. Therefore, it may also be possible to remove high vicious fluids out of the sample space, after analysis. Such a pressure air mechanism may also be used for drying the carrier plate after an experiment, in order to ensure that no impurities or contaminations remain in the sample space, to condition the sample space for the next experiment.

When providing different sample chambers laterally oriented with respect to one another, it should be ensured that no disturbing magnetic interaction between adjacent sample spaces (and therefore cover part/base part pairs) occurs. For this purpose, such adjacent elements should be spaced with a distance of, for instance, 10 mm or more from one another, or any suitable shielding elements for magnetic shielding may be provided.

Temperatures of the sample when being operated with the system according to an embodiment of the invention may be particularly in the temperature range between 20° C. and 95° C., in the case of micro arrays usually in the range of 40° C. to 60° C. However, the temperature may be varied over a broad range with the temperature control unit which may be optionally provided in the base part.

It is possible to provide a hole in the cover part for selectively exposing the sample space, for instance for a robot. For instance, such a hole may be selectively exposed using a tilting mechanism which automatically correlates shifting and tilting of cover part relative to the base part. Therefore, a mechanism can be provided so that a cover part motion (for instance tilting) automatically shifts also a hole so that the hole may be brought at least partially in alignment with the reaction chamber or sample space so as to allow to fill sample in the sample space via this hole only in case of such an at least partial alignment.

It is also possible to provide a sequence of recesses and protrusions with a linear extension in the base part, so that a pin forming the tilting axis (which pin is connected to the cover part) can slide into individual ones of the recesses in order to selectively shift the tilting axis to a desired value.

When providing the cover part to be slidable when opening the cover part with regard to the base part, a direct pipetting of sample onto tissue provided on a carrier element may be made possible.

The cover part may be provided with slidable chambers, thereby allowing replacement.

A blowing pulse may be effected on a surface of the sample space, for instance for drying such a surface and/or promoting removal of a fluid out of the sample space, after analysis. It is possible to use an air pressure connection usually provided in a lab or a compressor for supplying such a blowing pulse. It may be advantageous to provide a pressure of such a blow pulse of 2.5 bar.

According to an exemplary embodiment, a device for realizing a reaction chamber on an object carrier may be provided, wherein the device comprises a ground plate/base plate for receiving the object carrier. A cover part adapted for being mounted on the ground plate may be foreseen, and a frame adapted to be inserted into the cover part. An insert element which is adapted for being inserted in the frame may be provided as well. In an operation state, in which the cover part is mounted on the ground plate, the object carrier and the insert element may form a cavity as a reaction chamber.

With such a device, it may be possible to provide at least one magnetic fastening element in and/or on the base part for magnetically connecting the base part to a receiving surface, particularly on a heatable receiving surface.

Such a device may comprise at least one magnetic fastening element in and/or on the cover part for magnetically fastening the cover part at the base part, particularly by at least magnetic fastening element in and/or on the base part.

Such a device may further comprise at least one magnetic fastening element in and/or on the frame for magnetically fastening the frame at the cover part, particularly with at least one magnetic fastening element in and/or on the cover part.

The device may comprise a distance adjustment element adapted for adjusting a distance between the object carrier and the cover part.

Such a distance adjustment element may comprise a screw which is adapted to be guided through the cover part and having an end effecting a pressure on the base part.

The distance adjustment element may also be a pneumatically operable or actuable pin. The distance adjustment element may be a pin actuable using an engine, for instance an electromotor. The distance adjustment element may be adapted for maintaining a distance using a repulsive magnetic force. The distance adjustment element may be adapted for adjusting a modifiable or variable angle between the object carrier and the insert element.

The device may further comprise at least guide groove in the base part and at least one corresponding guide pin in the cover part. The device may comprise an injection opening in the cover part, wherein this injection opening may allow to insert a sample to be inserted in the reaction chamber between the object carrier and the insert element.

The device may be adapted for receiving a plurality of object carriers, frames and cover elements between a common cover part and a common base part. This plurality may be two, four, a number larger or equal ten or larger or equal hundred.

Furthermore, the device may be configured as an analysis device for analyzing a sample to be inserted in a reaction chamber, particularly using hybridization events.

Next, further exemplary embodiments of the sample handling device will be explained. However, these embodiments also apply for the module, for the method of handling a sample, for the program element, for the computer-readable medium, and for the insert element.

The base part may be provided spatially fixed, and the cover part may be provided movably. By taking this measure, it is possible that only one component has to be provided movably, reducing the effort when manufacturing the sample handling device. However, it is also possible that the base part may be provided movably, and the cover part may be provided spatially fixed, or that both components are moved.

The base part and the cover part may be tiltable with regard to one another. In other words, the angle between the base part and the cover part may be selectively modified. However, alternatively, it is also possible to shift the base part parallel with respect to the cover part so as to modify the size of the sample space, which may also allow to benefit from capillary forces. Exemplary tilting angles may be less than 30°, particularly less than 20°, more particularly less than 10°.

The first force generating element may be adapted to generate an attracting magnetic force. Such an attracting magnetic force may be generated by permanent magnets or by electromagnets. Electromagnets offer the option adjust the magnetic force by modifying an exciting current. Magnetic forces are easily producible and are strong enough to provide the necessary forces. Additionally or alternatively, the forces may be of mechanical type, of electric type (for instance two capacitor plates on which electric charges with different polarities are provided), may be spring forces, clamping forces, etc.

The first force generating element may comprise at least one first magnet arranged at the base part and may comprise at least one second magnet arranged at the cover part, the at least one first magnet and the at least one second magnet being adapted to attract each other. Therefore, the magnetic polarity of the first magnet(s) and the second magnet(s) may be opposite to one another (for instance a south pole and a north pole directed towards each other).

The first force generating element may be adapted to generate an attracting biasing force. The term “biasing force” may particularly denote a force which is always present, so that it does not have to be controlled by a control unit. This may simplify operation of the device. For example, such a constant biasing force may be realized using permanent magnets or spring elements. According to an exemplary embodiment, a magnetic biasing force may have the order of magnitude of 150 N.

The first force generating element may be adapted to generate an attracting force being time-independent. Therefore, this force is constant and does not have to be varied by an external control. This allows to operate the sample handling device with low effort, since only the second force generating element has to be actively controlled by the control unit.

The second force generating element may be adapted to generate a counterforce to promote an oscillatory motion of the base part and the cover part relative to each other to thereby influence the sample space to follow the oscillatory motion. Such an oscillatory motion may allow to open and close the two parts in a periodic sequence, allowing to provide a proper mixture of the fluidic sample and allowing to suck in the fluidic sample due to capillary forces or the like.

The second force generating element may be adapted to generate a counterforce being time-dependent. Therefore, the control unit may actively control only the second force generating element, wherein the time dependence of the generated counterforce (which may be repulsive at least a part of the time) may be in accordance with a sampling sequence or a sample handling sequence desired.

The second force generating element may comprise a reciprocating piston adapted for acting on the cover part to promote the motion of the base part and the cover part relative to each other. Such a piston may be driven by an electric motor and may move (for instance periodically) upwards and downwards with a controllable frequency and with a controllable amplitude or stroke distance. However, as an alternative to such a mechanical counterforce, the counterforce may be also generated magnetically, for instance by operating an electromagnet in a time-dependent manner. Also successive charging and discharging of a capacitor may allow to generate such a time-dependent force.

The reciprocating piston may be operable in a first operation state with a first stroke distance for supplying the sample to the sample space and is operable in a second operation state with a second stroke distance for mixing the sample in the sample space. The first stroke distance may be larger than the second stroke distance. A stroke with the first stroke distance may allow to insert the sample into the sample space, wherein a stroke with the second stroke distance may only provide a small vibration to mix the sample within the sample chamber.

Examples for the second force generating element or a distance adjustment element are any types of engines capable of generating such a force that a distance between the object carrier and the cover part may be changed, particularly an electromotor or a combustion motor. An exemplary embodiment implements a stepper motor, particularly a stepper motor having a spindle drive. In such an embodiment, a rotation motion may be transferred to a spindle which may then perform a reciprocating motion (“up and down”) to perform a predefined lift of stroke. Implementation of a stepper motor may be particularly advantageous in an embodiment in which one or modules for a sample handling device shall be mounted in a housing of a sample handling device. Such modules may be relatively autarkic components (each having an individual stepper motor) to thereby allow in a simple manner to specifically adjust a sampling handling capacity of a sample handling device to user preferences, for instance to install four, eight, sixteen, or forty-eight modules in a sample handling device.

The sample handling device may comprise a pneumatic drive unit adapted for pneumatically driving the piston. However, alternatively, the driving of the piston(s) may also be provided magnetically, electrically, or with a tooth wheel mechanism.

The sample handling device may further comprise a temperature control unit adapted for controlling a temperature of the sample in the sample space. Such a temperature control unit may be partially or entirely accommodated in the base part, allowing an efficient heating or cooling of the sample in the sample space. The temperature control unit may comprise an ohmic heating, that is to say a heating wire, a Peltier heater, a Peltier cooler or any other heating/cooling principle. It is possible to measure the temperature using a sensor and to adjust the temperature accordingly, thereby providing a temperature regulation unit.

The temperature control unit may also comprise a ventilating fan, particularly for cooling purposes. Such a ventilator or blower may cool the sample (or any other component of the sample handling device) by a cool gas (particularly air) stream, for instance by convection. Alternatively, expansion of pressurized gas (particularly air) may be used for cooling (but also for heating) purposes. Such a pressurized gas stream may transport heat off the sample space, or off the sample handling device.

The sample handling device may comprise a user interface adapted for enabling a user to control operation of the sample handling device. Such a user interface may include a display element (for instance an LCD display, a plasma device or a cathode ray tube) and may be therefore a graphical user interface (GUI). It is also possible that the user interface or input/output unit comprises input elements like a keypad, a joystick, a trackball, buttons or even a microphone of a voice recognition system. Via the user interface, the user may control different aspects, like a sampling handling operation mode or an analysis scheme, or an emergency switch. In case of an emergency, a button may be provided with which the user may simply stop the operation, for instance in order to prevent loss of a precious sample under investigation.

The sample handling device may comprise a sample supply unit adapted for supplying the sample to the sample space. Such a sample supply unit may be any configuration which allows to transport a fluid to be analyzed into the sample space.

Particularly, the sample supply unit may comprise an injection opening provided at the cover part and being in fluid communication with the sample space. Such an injection opening may allow to connect a tube or the like or a pipette for inserting the sample into the sample space.

The sample handling device may further comprise a magnetic closure element adapted for magnetically closing the injection opening comprising a ring magnet, wherein the magnetic closure element and the ring magnet may be adapted to attract each other. By taking this measure, it is possible in a sample insertion operation mode, to conveniently introduce a sample in the sample space. When the sample has been inserted, the magnetic closure element, for instance a small pin, may be inserted into the injection opening. When such a pin and the ring magnet are magnetically opposite in polarity, a tight magnetically based sealing may be enabled.

The cover part may be adapted for enabling or disabling access to the injection opening and synchronization with the motion of the base part and the cover part relative to each other. In other words, the injection opening may also be closed in an operation mode in which it shall be prevented that sample passes through the opening. For example, when the sample has been inserted during the experiment, the injection opening may be closed.

Particularly, the cover part may be adapted for enabling access to the injection opening in an operation state in which the cover part is tilted relative to the base part by an angle of at least a threshold value, and is adapted for disabling access to the injection opening in an operation state in which the cover part is tilted relative to the base part by an angle of less than the threshold value. For this purpose, tilting and a linear sliding between base part and cover part may be mechanically synchronized. When opening the cover part with respect to the base part, and when this opening exceeds the threshold angle, the injection opening may be shifted with respect to the sample space so that access becomes possible. When the angle becomes smaller, the injection opening is shifted back with respect to the sample space preventing external access to the sample space.

The sample supply unit may comprise a tube coupling the injection opening with a sample reservoir. Such a sample reservoir may include one or a plurality of containers of liquids, samples, buffer solutions, rinse fluid, etc. or a waste unit so that a uni-directional or bi-directional fluid communication becomes possible from the injection opening through the tube and to the containers, or in the opposite direction.

The sample supply unit may comprise a robot supplying the sample to the sample space via the injection opening. By implementing a robot, almost all procedural steps of the sampling procedure may be automated.

The control unit may be adapted for synchronizing a sample supply scheme according to which the sample supply unit supplies the sample to the sample space and a motion scheme according to which the base part and the cover part are moved relative to each other for influencing the sample space. Such a synchronization may harmonize all the operation procedures so that the entire analysis procedure may be automated.

The cover part may be substitutable for adjusting at least one of the group consisting of a size of the sample space, and a number of sample spaces. Therefore, a modular system may be provided in which a cover part may be mounted on the base part which has a number of sample spaces and/or a size of sample spaces which is in accordance with the requirements of a specific experiment. Therefore, the number of experiments to be performed and the sample volume being available may be adjusted to the sample handling device. Particularly, a set of insert elements of different sizes and/or of different configurations (for example with regard to a fluid supply mechanism) may be provided and adapted for insertion into a frame to be inserted into the cover part or for direct insertion into the cover part without a frame. Thus, the insert elements may be disposable or single-use devices provided for different applications or experiments. Such insert elements may comprise a fluid injection opening through which a fluidic sample may be guided to be supplied to the sample space. Such insert elements may also be free of a fluid injection opening, and may comprise a fluid accumulation projection or a fluid accumulation edge to which a fluidic sample may be guided to be supplied to the sample space. FIGS. 16, 17, FIG. 18, and FIG. 19 to FIG. 21 show three insert elements forming a set or kit, wherein each or these insert elements may be used with the same sample handling device, depending on a desired application.

The sample handling device may comprise a ventilation unit adapted for ventilating the sample space. Such a fan or blower may allow to provide the sample space, particularly a surface of the base part or of a carrier element, with an air stream allowing to dry and/or clean such a portion, preventing contamination.

The sample handling device may comprise at least one object carrier adapted to be accommodated by the base part and adapted for carrying at least one object under examination to be brought in contact with the sample. Such an object carrier may be a substrate (for instance made of plastic, glass, semiconductor, ceramics, etc.), a plate, a fluidic chip device and a micro array. Such a micro array may have a matrix-like arrangement of test molecules, for instance for a hybridization experiment.

The control unit may further be adapted for substituting the at least one object carrier by another object carrier upon completion of an analysis of the object carrier and the sample. Therefore, the control unit may automate also the object carrier replacement procedure, for instance by providing a robot with corresponding gripper elements.

The sample handling device may comprise at least one frame adapted for being accommodated by the cover part. Such a frame may have essentially the structure of a window frame in which a corresponding element can be inserted and which can, in turn, be inserted itself in the cover part. Therefore, a fastening mechanism between frame and cover part may be provided, for instance magnetically or mechanically.

In a magnetic configuration, the sample handling device may comprise at least one third magnet arranged at the at least one frame and may comprise at least one forth magnet arranged at the cover part, wherein the at least one third magnet and the at least one forth magnet are adapted to attract each other. Such an attracting magnetic force may simplify for a user insertion of the frame into the cover part.

Furthermore, the sample handling device may comprise at least one insert element adapted for being inserted in the at least one frame. Such an insert element may be essentially made of a plastic material and may be a disposable unit.

The insert element may comprise a flexible seal ring biased for sealing the sample space in an operation state in which the cover part and the base part have a minimum distance from one another. Therefore, a mechanical biasing force may be generated by the biased flexible seal ring.

The insert element may comprise an essentially planar plate in which a mechanically reinforcing structure may be formed. This essentially planar plate may have a first surface which is to be directed toward the sample space and which may be completely planar. It may also have a second, opposing surface in or on which the mechanically reinforcing structure may be formed. On the essentially planar surface, one or more small protrusions may be selectively provided wherein these protrusions allow to maintain a minimum space between the surface of the base part or object carrier on the one hand and the planar surface of the insert element on the other hand.

The mechanically reinforcing structure may comprise at least one of the group consisting of a framework structure, a cross structure (having one or more crosses), a matrix structure, a star structure (having a central point and braces going in different directions), and a star structure having a central bump. Such a central bump may be a small cylindrical or disc-like structure from which the different braces extend to the different directions.

The insert element may comprise an alignment marker adapted for disabling insertion of the insert element in case of an improper orientation of the alignment marker relative to the at least one frame. Therefore, such an alignment marker may be any protrusion which allows insertion of the insert element into the frame or into the cover part only when a corresponding recess is present there. Alternatively, the recess may be provided in the insert element and the protrusion may be provided in the frame or base part. This may prevent erroneous use of the device and allows operation of the device even by a user having low skills.

The base part may comprise a guide groove, and the cover part may comprise a guide pin adapted for cooperation with the guide groove. Alternatively, the base part may comprise a guide pin, and the cover part may comprise a guide groove adapted for cooperation with the guide pin. By such cooperating fastening elements, it is possible to insert the base part into the cover part, or vice versa, with low effort and in an intuitive manner.

The sample handling device may further comprise at least one insert element adapted for being inserted in the cover part. Therefore, in contrast to the configurations described above, the insert element needs not necessarily to be inserted into a frame before the frame is inserted into the cover part, but the insert element may be inserted in the cover part itself. This may allow to reduce the number of components of the sample handling device.

The at least one insert element according to the previously described configuration may be adapted for being inserted in the cover part by a snap-in mechanism. Therefore, corresponding fastening elements may be provided at the insert element and/or at the cover part.

The injection opening may be located essentially at a pivoting axis around which the base part and the cover part may be tiltable with regard to one another. This geometrical arrangement may allow for a proper insertion of the fluidic sample into the sample space.

The sample handling device may be adapted as an analysis device for analyzing the sample injected into the sample space, particularly based on hybridization events. However, the analysis device may be used for very different fields, for any kind of sensor devices, and for any life science apparatus.

The aspects defined above and further aspects of the invention are apparent from the examples of embodiment to be described hereinafter and are explained with reference to these examples of embodiment.

### BRIEF DESCRIPTION OF THE DRAWINGS

The invention will be described in more detail hereinafter with reference to examples of embodiment but to which the invention is not limited.

FIG. 1 illustrates a schematic view of a sample handling device according to an exemplary embodiment of the invention.

FIG. 2 shows a three-dimensional view of a sample handling device according to an exemplary embodiment of the invention.

FIG. 3 illustrates a partially exploded view of a sample handling device according to an exemplary embodiment of the invention.

FIG. 4 illustrates a cross-sectional view of a sample handling device according to an exemplary embodiment of the invention.

FIG. 5 to FIG. 7 show partial exploded views of a sample handling device according to an exemplary embodiment of the invention.

FIG. 7A shows cross-sectional views of a sample handling device according to an exemplary embodiment of the invention.

FIG. 8 shows different views of a sample holding portion of a sample handling device according to an exemplary embodiment of the invention.

FIG. 9 shows different views of a sample holding portion of a sample handling device according to an exemplary embodiment of the invention.

FIG. 10 shows a plan view and a cross-sectional view of a sample holding portion of a sample handling device according to an exemplary embodiment of the invention.

FIG. 11 shows a partially exploded view of a sample holding portion of a sample handling device according to an exemplary embodiment of the invention.

FIG. 12 shows a partially exploded view of a sample holding portion of a sample handling device according to an exemplary embodiment of the invention.

FIG. 13 shows details of a sample holding portion of a sample handling device according to an exemplary embodiment of the invention.

FIG. 14 shows a three-dimensional view of a sample holding portion according to an exemplary embodiment of the invention.

FIG. 15 shows a cross-sectional view of a sample holding portion of a sample handling device according to an exemplary embodiment of the invention.

FIG. 16 to FIG. 21 show different views of sample holding portions of a sample handling device according to exemplary embodiments of the invention.

FIG. 22 and FIG. 23 show three-dimensional views of sample handling devices according to exemplary embodiments of the invention.

FIG. 24 to FIG. 27 show three-dimensional views of a module for a sample handling device of FIG. 22 or FIG. 23 according to an exemplary embodiment of the invention.

### DESCRIPTION OF EMBODIMENTS

The illustration in the drawing is schematically. In different drawings, similar or identical elements are provided with the same reference signs.

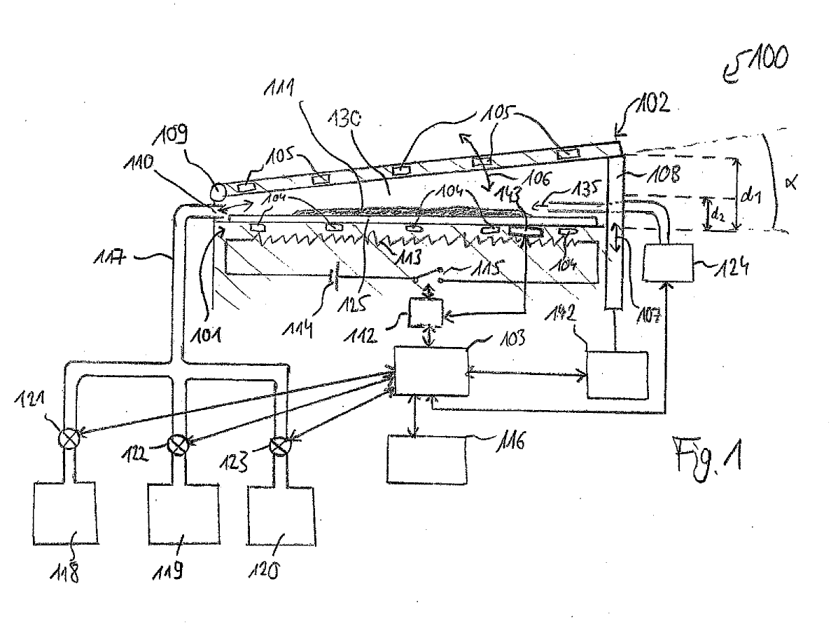

In the following, referring to FIG. 1, a sample handling device 100 according to an exemplary embodiment of the invention will be explained.

The sample handling device 100 comprises a base part 101 and a cover part 102. Furthermore, a first force generating unit is provided which will be described in more detail in the following and which is adapted to generate an attracting magnetic force promoting attraction between the base part 101 and the bottom part 102. Beyond this, a second force generating unit which will be described in the following in more detail is provided and which is adapted to generate a counterforce having a component being oriented opposite to the attracting force to promote a motion of the base part 101 and the cover part 102 relative to each other.

Furthermore, a central processing unit 103 (CPU) is provided as a control unit for controlling the second force generating unit for moving the base part 101 and the cover part 102 relative to each other for influencing dimensions of a variable sample space 130 delimited between the base part 101 and the cover part 102 for accommodating a fluidic sample. In the embodiment of FIG. 1, the base part 101 is spatially fixed, and the cover part 102 is provided tiltable 106 with regard to the base part 101.

The first force generating unit generates an attracting magnetic force by means of a plurality of first magnetic elements 104 embedded in the base part 101 in cooperation with a plurality of second magnetic elements 105 embedded in the cover part 102 and being adapted to attract the first magnetic elements 104. In other words, the magnetic polarity of the magnets 104 and of the magnets 105 is selected in such a manner that an attractive force is generated by adjacent ones of the magnetic elements 104 and 105. Therefore, the first force generating unit generates a static attractive force which has a direction (at least at small tilting angles α) which is oriented essentially in a vertical direction in FIG. 1, from an upper part to a lower part of the device 100.

In contrast to this, the second force generating unit generates a counterforce to the force to promote an oscillatory motion indicated by reference numeral 106 of the base part 101 and the cover part 102 relative to each other to thereby influence the dimension of the sample space 130 which follows the oscillatory motion. In other words, the second force generating unit allows to induce the tilting motion 106 by providing a force which can have a direction (at least at small tilting angles α) essentially parallel or essentially anti-parallel to the force generated by the first force generating unit. Therefore, the combination of an attracting magnetic force between the base part 101 and the cover part 102 and a controllable repulsive (mechanical and gravitational) force between the two components 101, 102 allows to externally control the repeated tilting with high accuracy.

In more detail, the second force generating unit comprises a piston 108 which is capable of reciprocating, as indicated with reference numeral 107. The reciprocating piston 108 contacts a lower surface of the cover part 102 and is therefore adapted for acting on the cover part 102 to promote the motion of the base part 101 and the cover part 102 relative to each other. In other words, when the piston 108 moves in an upward direction according to FIG. 1, the cover part 102 being connected with the base part 101 via a hinge 109 follows this upward motion of the reciprocating piston 108 in an upper direction of FIG. 1, so as to increase the tilting angle α. When the piston 108 moves downwardly referring to FIG. 1, the base part 101 follows this motion (under the additional influence of a gravitational force), thereby reducing the tilting angle α.

The reciprocating piston 108 is operable in a first operation state with a first stroke distance d₁ for supplying a sample to the sample space 130, and is operable in a second operation state with a second stroke distance d₂ for mixing the sample in the sample space 130. The first stroke distance d₁ is larger than the second stroke distance d₂. When the sample is injected in the sample space 130 via a supply opening 110, capillary forces between an inner surface of the cover part 102 and an upper surface of the base part 101 forces the sample to be transported towards an object under examination 111, in the present example a tissue sample. For this purpose, the reciprocating piston 108 may oscillate with the first stroke distance d₁. In the second operation state, when the sample is already present in the sample space 130, it may be appropriate to properly mix the sample with the tissue sample 111. For this purpose, only a small amplitude oscillation with the stroke distance d₂ is performed.

As can be taken from FIG. 1, a pneumatic drive unit 142 (which may also include an electromotor) is provided for pneumatically driving the piston 108. The pneumatic drive unit 142 may be a valve island or a valve arrangement for an elevating mechanism. A gas pressure (for example an air stream) may selectively open or close the valve(s). The pneumatic drive unit 142 may also comprise a motor control with a position adjustment.

Furthermore, a temperature control unit 112 is provided and adapted for controlling a temperature of the sample and the tissue sample 111 in the sample space 130. For this purpose, an ohmic heating wire 113 is provided which can be heated to generate thermal energy using a direct current (DC) source 114. A switch 115 can be closed or opened selectively under the influence of the temperature control unit 112 which is, in turn, controllable by the control unit 103. Furthermore, a temperature sensor 143 is located close to the sample space 130. The temperature sensor 143 measures the temperature in the sample space 130 and provides a signal indicative of the present temperature to the temperature control unit 112. The temperature control unit 112 triggers the switch 115 to be opened or closed depending on whether it is presently desired to provide thermal energy to the sample space 130, or not. When the switch 115 is closed, current provided by the DC source 114 can flow through the ohmic heating wire 113, thereby heating the base part 101. When such a heating is not desired, the temperature control unit 112 and/or the control unit 103 operates the switch 115 to be open. No current can be provided by the DC source 114 in this operation state.

Beyond this, an input/output unit 116 is provided for enabling a user to control operation of the sample handling device 100. The user interface 116 is capable of influencing operation of the control unit 103, thereby controlling the entire processing or sample handling. Although not shown in FIG. 1, the user may control via the input/output device 116 a sample handling operation mode or may define a complex life science analysis experiment. The user interface 116 can also have features like an emergency switch by means of which a user can terminate operation of the device 100 immediately, for instance in case of an emergency or to prevent a precious sample from getting lost.

In the following, a sample supply system adapted for supplying the sample to the sample space 130 will be described in more detail. The sample can be any fluidic sample to be injected into the sample space 130 via the opening 110.

Particularly, the sample supply device comprises a tube 117 which is bifurcated and which couples the sample injection opening 110 with a plurality of fluid reservoirs, namely a first sample reservoir 118 accommodating a first sample, a second sample reservoir 119 accommodating a second sample and a waste container 120. A first valve 121, a second valve 122 and a third valve 123 are provided to selectively close or open specific fluid communication paths of the sample supply system and can be individually opened or closed under the control of the CPU 103. For example, when the first valve 121 is opened and the second and third valves 122, 123 are closed, sample from the first sample container 118 can be supplied, for instance using a pump (not shown) or the like, via the opening 110 into the sample space 130. When the second valve 122 is opened and the first and third valves 121, 123 are closed, sample from the second sample reservoir 119 may be supplied via the opening 110 into the sample space 130. After an experiment in the sample space 130, that is to say after a chemical or biochemical reaction between the injected sample and the tissue sample 111 is finished, fluid material can be removed from the sample space 130 (for instance by reversing a pump direction of the pump which is not shown in FIG. 1) and can be transported via the bifurcated tube 117 into the waste container 120.

By simultaneously controlling the electromotor 142, the valve operations 121 to 123, and further units, as indicated in FIG. 1, the control unit 103 is adapted for synchronizing the sample supply scheme according to which the sample supply system described supplies the sample to the sample space 130 with a motion scheme according to which the base part 101 and the cover part 102 are moved relative to each other for influencing the actual dimension of the sample space 130, which is defined by the tilting angle between the base part 101 and the cover part 102.

As can further be taken from FIG. 1, a ventilation unit 124 is provided which is also controlled by the CPU 103 and which is adapted for generating a gas blow indicated by reference numeral 135, for example for drying the sample space 130. When having removed a sample from the sample space 130 after completion of an analysis or experiment, such a ventilation unit 124 may accelerate reconditioning of the sample space 130 for a new experiment and may support the removal even of highly viscous fluids out of the sample space 130. The ventilation unit 124 may provide compressed air (which may be taken from a compression air supply as can be found in many laboratories), wherein a supply with compressed air may be switched on or off, by opening or closing a valve between the ventilation unit 124 and the sample space 130. Additionally or alternatively, the ventilation unit 124 may be a ventilator or fan. The ventilation unit 124 may cool the sample space 130.

As can further be taken from FIG. 1, a glass plate is provided as an object carrier 125, is positioned on an upper surface portion of the base part 101 and is adapted for carrying the tissue sample 111 to be brought in contact with the sample to be injected via the injection opening 110. The object carrier 125 can simply be put on a surface of the base part 101 and is substitutable. Alternatively, the object carrier 125 can be omitted and the sample 111 can be located directly on a surface of the bottom part 101.

As shown in FIG. 1 schematically, the injection opening 110 is located essentially at a pivoting axis or very close to the hinge 109 which extends perpendicular to the paper plane of FIG. 1 and around which the base part 101 and the cover part 102 are tiltable with regard to one another. With such a geometry, a very efficient sample supply may be made possible.

In the following, the operation of the sampling system 100 will be described in more detail.

Before starting an experiment, the cover part 102 may be opened to allow to put the object carrier 125 on the base part 101. This procedure can be performed manually by a human operator or can be performed by a robot, to further automate operation of the system 100. After this, the cover part 102 may be closed, and sample may be supplied from one of the sample containers 118, 119 through the tube 117 and the injection opening 110 into the sample space 130. In order to distribute the sample within the sample space 130, the cover part 102 is tilted to reduce the tilting angle between cover part 102 and base part 101. Consequently, capillary forces affect the sample and distribute the sample over the surface of the tissue sample 111. For this purpose, the reciprocating piston 108 is lowered towards the bottom part of FIG. 1, allowing the magnets 105, 104 to generate an attracting force. In order to allow properly mix the injected sample and the tissue 111, the piston 108 may oscillate with the small stroke d₂, whereas for distributing the sample over the entire sample space 130, the large sample stroke d₁ may be used.

Then, the tissue sample 101 may react with the fluidic sample supplied through the tube 117. A result of this may be detected by a detection unit (not shown in FIG. 1) of the device 100, or can be detected externally of the device 100. In the latter case, the cover part 102 is opened again and the object carrier 125 which may comprise an indicia or an identifier thereon (for instance a bar code or the like) may be removed from the apparatus 100 for further external analysis. Again, this operation can be performed manually or using a robot. The latter scenario may be again controlled by the control unit 103.

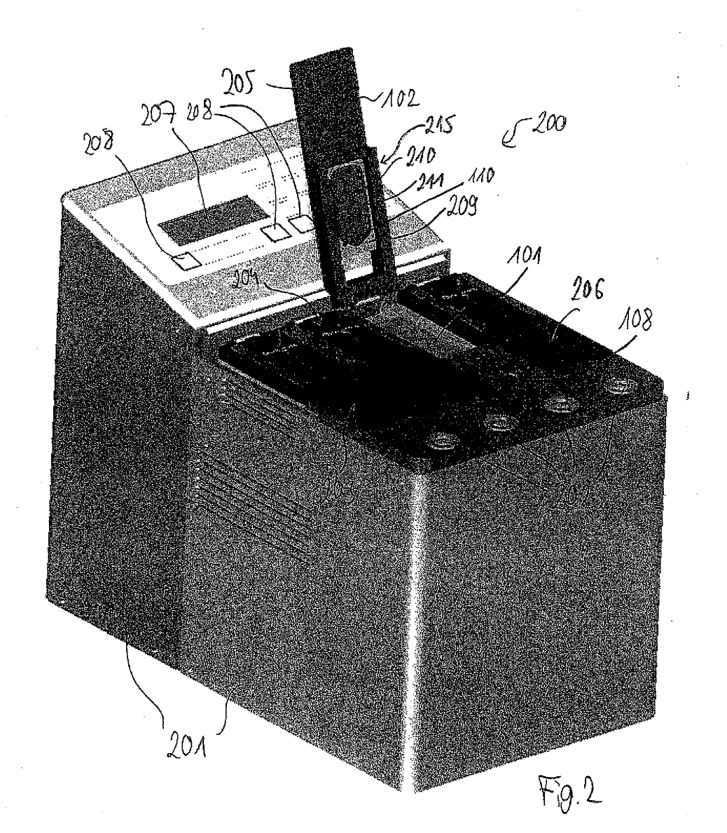

In the following, referring to FIG. 2, a three-dimensional view of a sample handling device 200 for handling a fluidic sample according to another exemplary embodiment of the invention will be explained.

In the embodiment of FIG. 2, a housing 201 is shown in which a plurality of the components of the sample handling device 200 are integrated.

Control buttons 202 may allow to individually control four individually operable fluid handling units 203 to 206. A display 207 for displaying operation information is shown, as well as buttons 208 allowing a user to operate the entire system 200.

The first, second and forth modules 203, 204 and 206 are closed in the configuration of FIG. 2, whereas the third module 205 is opened so as to expose an interior of the sample handling device 200. A piston 108 is shown in a non-extracted state in FIG. 2. The piston 108 is capable of affecting a force onto a cover part 102 of the third module 205 in a closed state. Furthermore, the base part 101 of the third module 205 is exposed, and a carrier plate 125 may be put on top of the base part 101.

A frame 209 is inserted using a magnetic force into the cover part 102. Furthermore, an insert element 215 having a planar plastic plate 210 surrounded by a sealing O-ring 211 made of a rubber material is inserted using mechanical forces, that is to say by clamping or the like, into the frame 209. An injection opening 110 is formed as a part of the sealing O-ring 211 in the insert element 215.

A user may freely open and close the cover part 102 so as to (re)place an object carrier 125 on the base part 101. Then, the cover part 102 may be closed, and a sample may be filled in through the injection opening 110. In order to accurately distribute the sample over the sample space, the piston 108 may be made to reciprocate upwardly and downwardly referring to FIG. 2. Capillary forces then force the fluidic sample inserted through the injection opening 110 to be distributed essentially over the entire sample space.

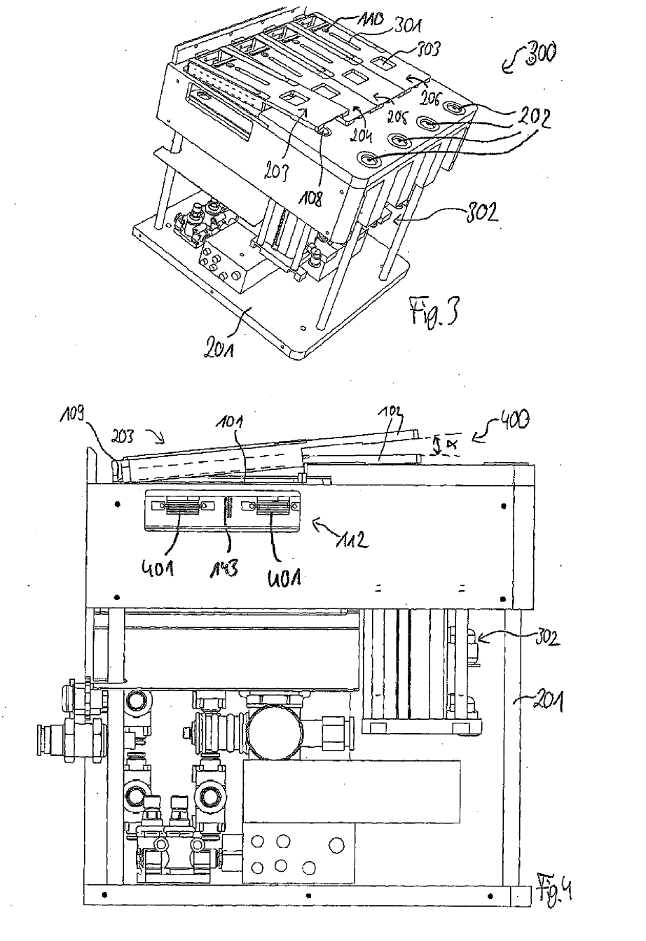

FIG. 3 shows a sample handling device 300 according to an exemplary embodiment of the invention which is similar to the sample handling device 200.

Each of the modular components 203 to 206 is shown in more detail in FIG. 3. Each of these components 203 to 206 comprises an inspection slit 301 allowing a user to visually inspect an interior of the sample space from an exterior position. Furthermore, details of a pneumatic system 302 for driving the piston 108 are shown. An opening 303 may be foreseen and may allow an external fluid supply unit (like a robot or a pipette or a fluid supply needle of an autosampler) to supply a fluid (for instance a fluidic sample) from an exterior position through the opening 303 into the sample space 130.

For example, a tissue sample having a size of 5 mm×5 mm may be positioned on a glass plate. A robot may then supply the fluidic sample using a pipette through the opening 303 onto the tissue sample.

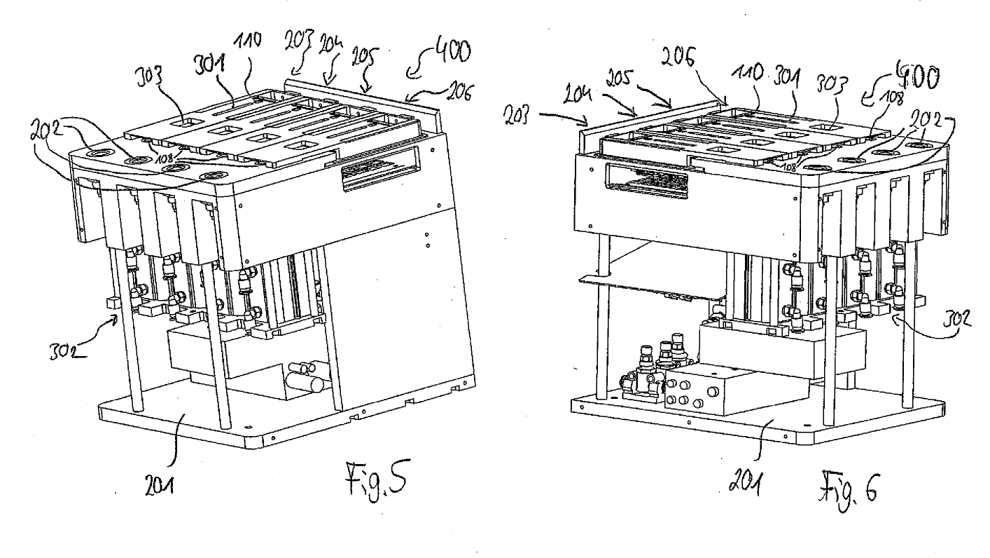

FIG. 4 shows a cross-sectional view of a sample handling device 400 according to an exemplary embodiment of the invention.

The cover part 102 is shown in an elevated state and in a lowered state, which differ by a tilting angle α.

Furthermore, a temperature control unit 112 is shown in more detail which is configured as an ohmic heating element in the described embodiment. The temperature control unit 112 includes the temperature sensor 143 located between two ohmic heat resistances 401.

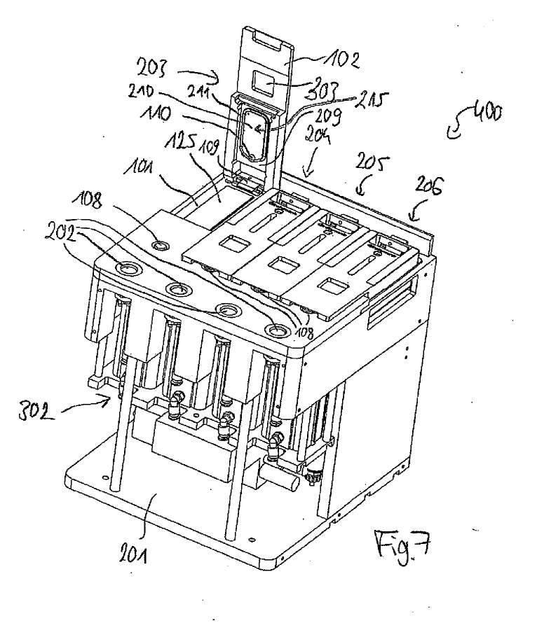

FIG. 5 to FIG. 7 show different partially exploded views in different operation states of the device 400.

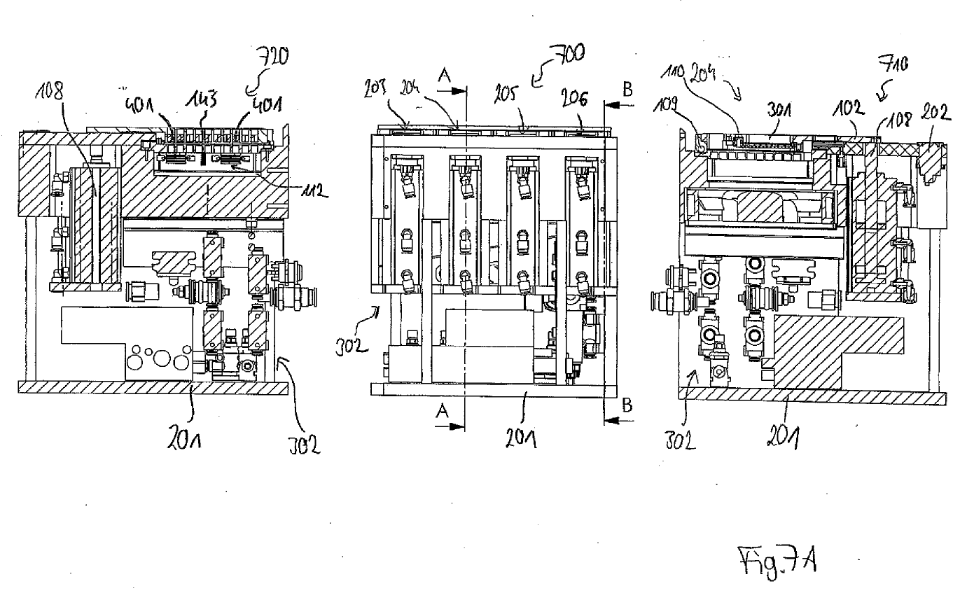

FIG. 7 shows the device 400 in an operation state, in which an object carrier 125 in form of a substitutable glass plate is inserted on a surface of the base part 101.

FIG. 7A comprises an illustration 700 which is a cross-sectional view of the device 400. Furthermore, FIG. 7A shows an illustration 710 which is a cross-section along the line A-A of the illustration 700. Beyond this, FIG. 7A shows an illustration 720 which is a cross-section along the line B-B of the illustration 700.

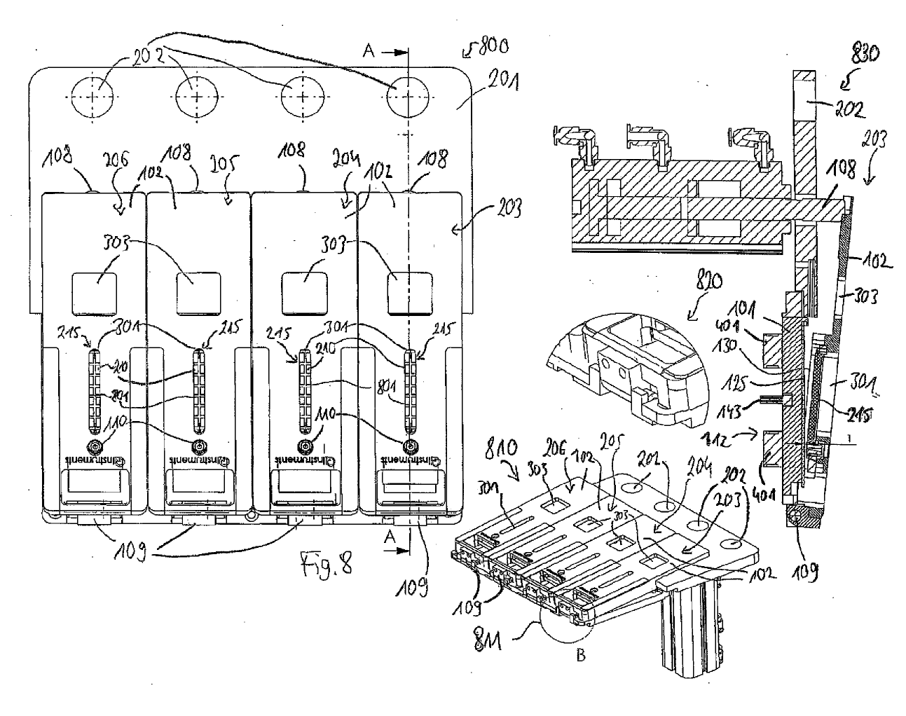

FIG. 8 shows different more detailed views of a sample holding portion of the device 400.

A plan view 800 shows a surface portion of the insert element 215 which surface portion opposes the sample space. This surface portion of the insert element 215 comprises a reinforcing structure 801 in form of cross-like braces. These may serve for mechanically stabilizing the system.

A three-dimensional illustration 810 shows further details. A hinge portion 811 is shown in a larger detail in an illustration 820. Beyond this, a cross-sectional view 830 shows a cross-section along a line A-A of the illustration 800.

In a similar manner like FIG. 8, FIG. 9 shows a plan view 900, a three-dimensional view 910, an enlarged view 920 of a hinge portion 911, and a cross-sectional view 930 along an axis A-A of the illustration 900.

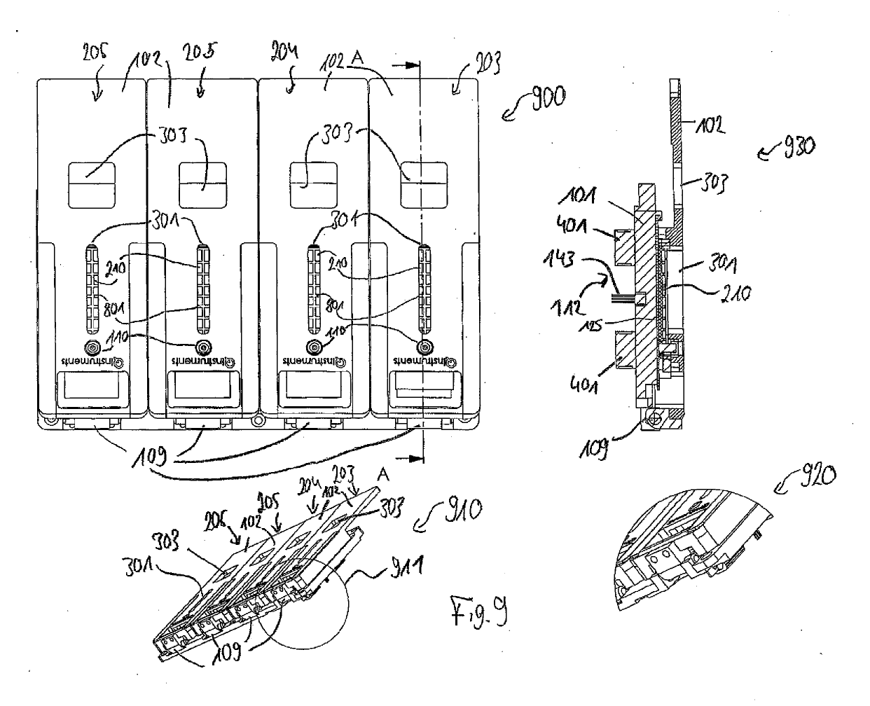

FIG. 10 again shows a plan view 1000 and a cross-sectional 1010 along a line A-A of the illustration 1000.

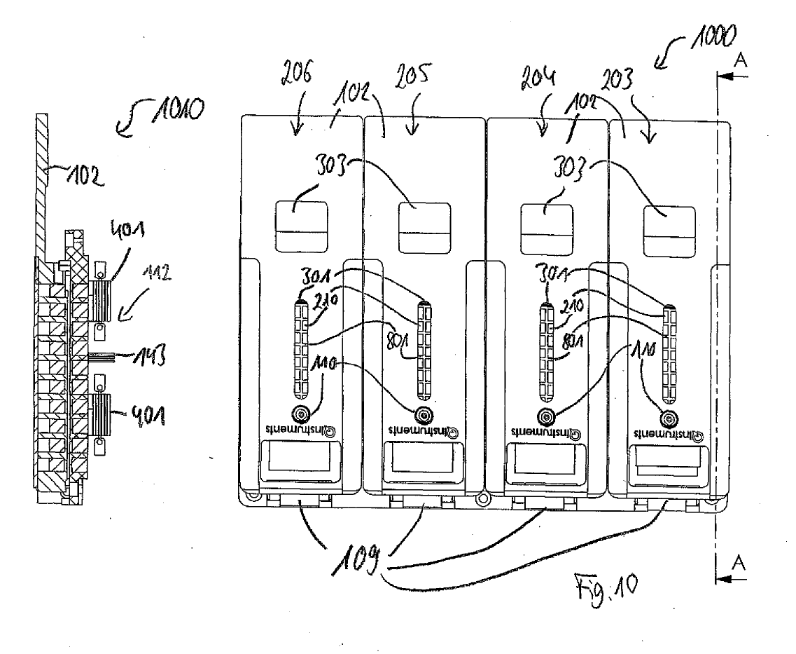

FIG. 11 shows a bottom view 1100 of a portion of an apparatus of FIG. 8 to FIG. 10.

Particularly, permanent magnetic elements 1101 are shown which are formed in the bottom part 101 and which generates an attracting force with cooperating permanent magnetic elements 1401 provided in the cover part 102 (see FIG. 14). Moreover, permanent magnetic elements 1102 are shown which are formed in the frame 209 and which generate an attracting force with permanent magnetic elements provided in the cover part 102 for facilitating insertion of the frame 209 in the cover part 102.

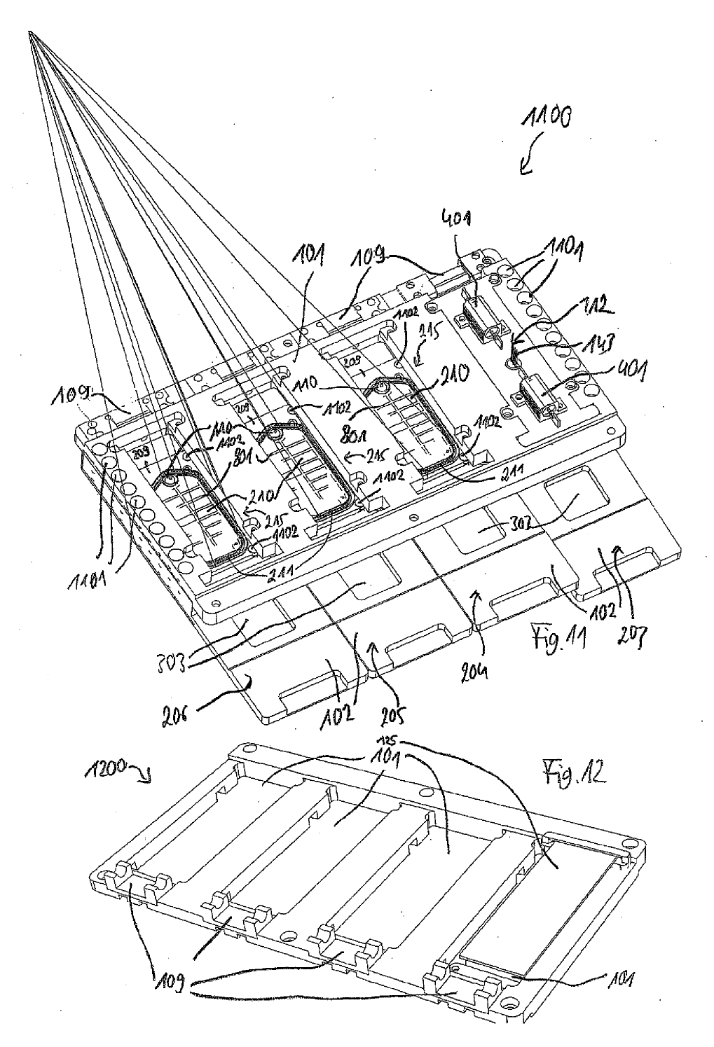

FIG. 12 shows a partially exploded view 1200 of a sample holding portion of a sample handling device according to an exemplary embodiment of the invention.

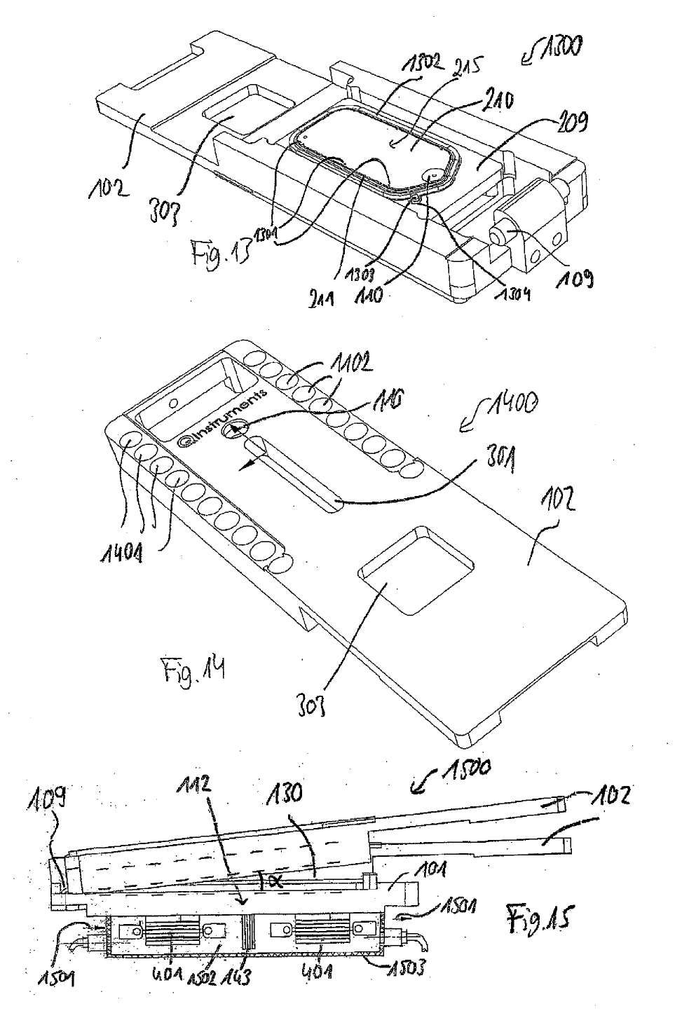

FIG. 13 shows a bottom view 1300 of the cover part 102 further showing an essential planar surface 210 of the insert element 215 which forms a limiting surface for the sample space. At several, for instance six, positions of the planar surface 210 of the insert element 215, small protrusions 1301 extending 50 μm from the surface 210 are formed along a circumference of the plate-like element 210. The height of this plurality of pins 1301 may define a minimum volume available for a sample in the sample space. The O-ring 211 separates the plate-like portion 210 from a surrounding ring-like rigid portion 1302 of the insert element 215. A biasing force is generated by the plate 210 slightly pressing against the object carrier (not shown in FIG. 13) as a result of the manner it is beared by the sealing ring 211.

As can further be taken from FIG. 13, the insert element 215 comprises a protrusion 1303 as an alignment marker adapted for disabling insertion of the insert element 215 into the frame 209 in case of improper orientation of the alignment marker 1303 with respect to a corresponding recess 1304 formed in the frame 209.

FIG. 14 illustrates an upper view 1400 of the cover part 102. Magnetic elements 1401 are shown.

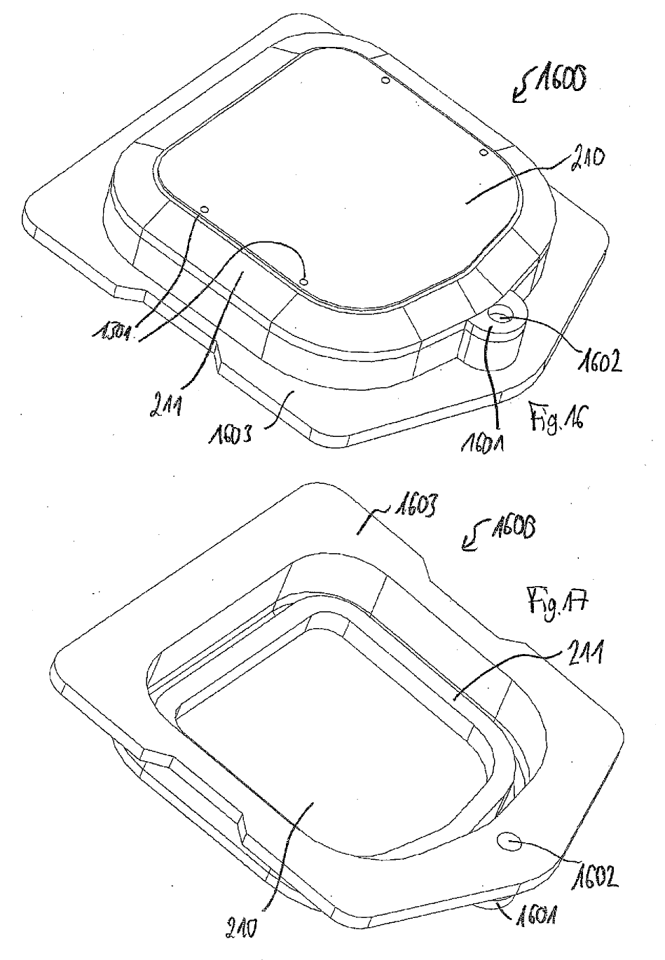

FIG. 15 illustrates again the cover part 102 in an elevated state and in a lowered state.

Details of a temperature control unit 112 are shown in FIG. 15. A stream of compressed air 1501 (for example at a temperature of 25° C. and a pressure of 2.5 bar to 3 bar) may be injected (controlled by valves which enable or disable supply of the stream of compressed air 1501) into a cavity 1502 defined by a box 1503. Such a stream of compressed air 1501 may cool the cavity 1502 delimited by the box 1503, for instance by heat convection or the like. Such a cooling may also cool the sample space 130 and/or the heating resistances 401. As an alternative to a cooling scheme using a stream of compressed air 1501, it is also possible to cool by a water flow, or by any other fluidic cooling component.

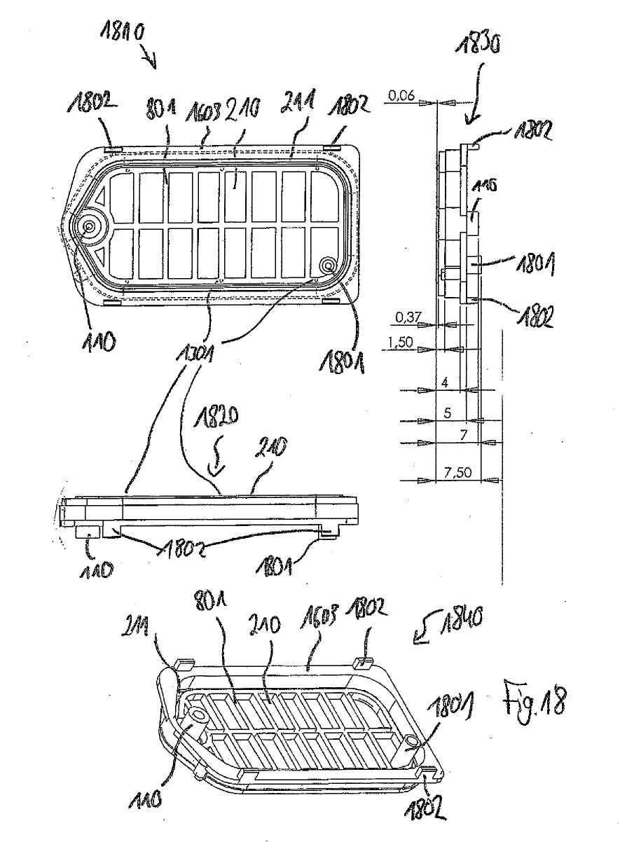

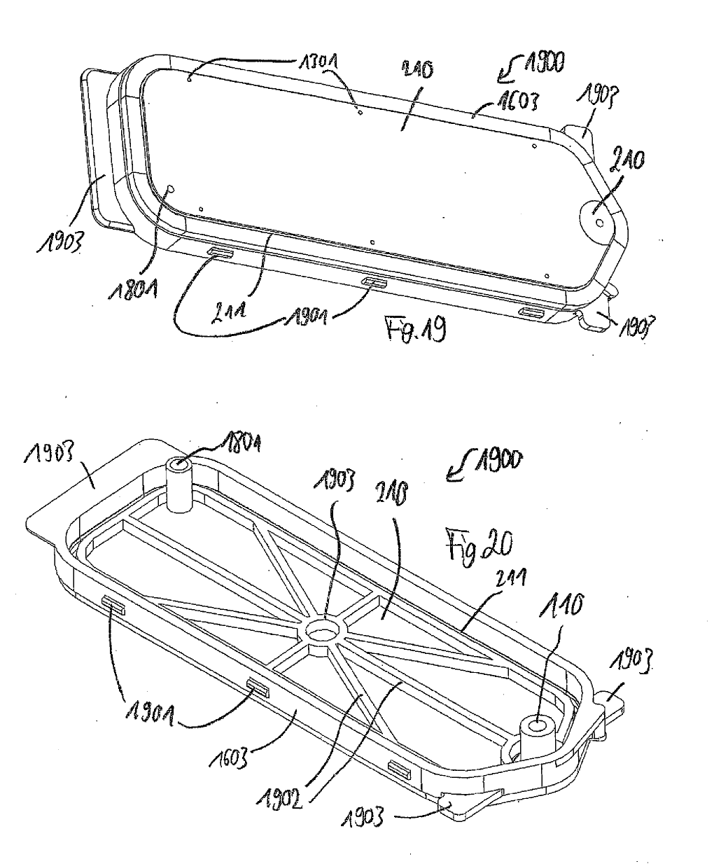

FIG. 16, and FIG. 17 illustrate an insert element 1600 according to an exemplary embodiment of the invention.

FIG. 16 shows a surface of the insert element 1600 being oriented, during normal use, towards a sample space.

The insert element 1600 does not comprise a separate injection opening 110, but instead of this a nipple or fitting or protrusion 1601 positioned close to an end portion of the plate 210. In order to allow to insert the insert element 1600 into a frame 209 or into a cover part 102, a fastening component 1603 is provided to laterally surround the seal 211.

The insert element 1600 is free of a separate injection opening 110 in the reaction chamber. Instead of such a component, the insert element 1600 comprises the nipple 1601 at one end of the reaction chamber, wherein an injected fluid (like a fluidic sample or a rinse buffer) accumulates close to the nipple 1601. A hole 1602 is foreseen at the nipple 1601 which may be connected to a tube or to a pipette allowing to introduce the fluid by (for instance manually) pipetting. Due to capillary forces, the fluid is forced to flow into the reaction chamber through the hole 1602 when the cover part is lowered.

The dimension of the reaction chamber may be 18 mm×18 mm with a volume of 20 μl.

FIG. 17 shows a surface of the insert element 1600 being oriented, during normal use, opposing a sample space.

FIG. 18 illustrates different views of an insert element according to an exemplary embodiment of the invention.

FIG. 18 shows a plan view 1810, side views 1820, 1830, and a three-dimensional view 1840.

In addition to the fluid injection opening 110, the insert element of FIG. 18 comprises an additional fluid injection (or draining) opening 1801. Snap-in fastening elements 1802 are foreseen for connecting the insert element to a frame or directly to a cover part.

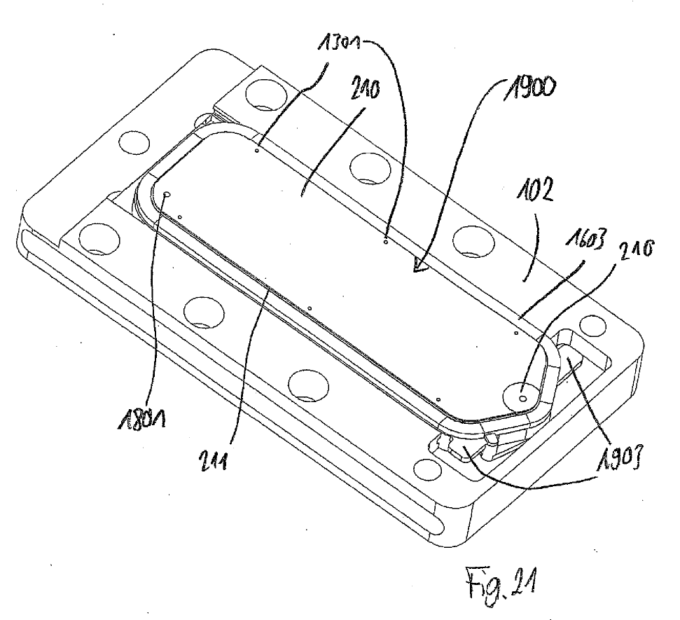

The dimension of the reaction chamber may be 40 mm×20 mm with a volume of 55 μl. FIG. 19 to FIG. 21 illustrate an insert element 1900 according to an exemplary embodiment of the invention.

FIG. 19 shows a surface of the insert element 1900 being oriented, during normal use, towards a sample space.

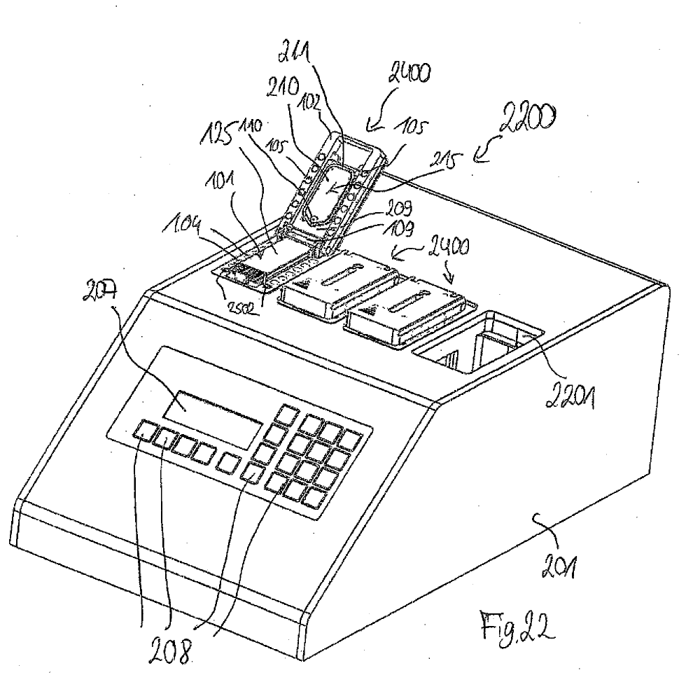

FIG. 20 shows a surface of the insert element 1900 being oriented, during normal use, opposing a sample space.

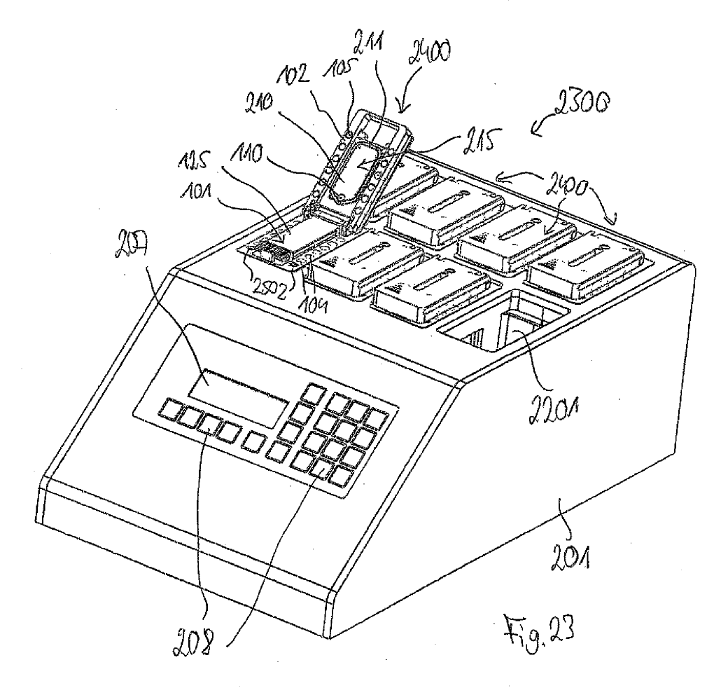

FIG. 21 shows the insert element 1900 in an operation state in which it is inserted into a cover part 102.

The insert element 1900 comprises lateral fastening projections 1901, a star like framework structure 1902 having a central bump 1903, and front and back projections 1903. The lateral fastening projections 1901 and the front and back projections 1903 serve for insertion of the insert element 1900 directly into the cover part 102 without the need of a frame (for instance of aluminum), as indicated in FIG. 21.

The dimension of the reaction chamber may be 62 mm×20 mm with a volume of 150 μl.

The embodiment of FIG. 19 to FIG. 21 realizes the reaction chamber over the entire glass object carrier.

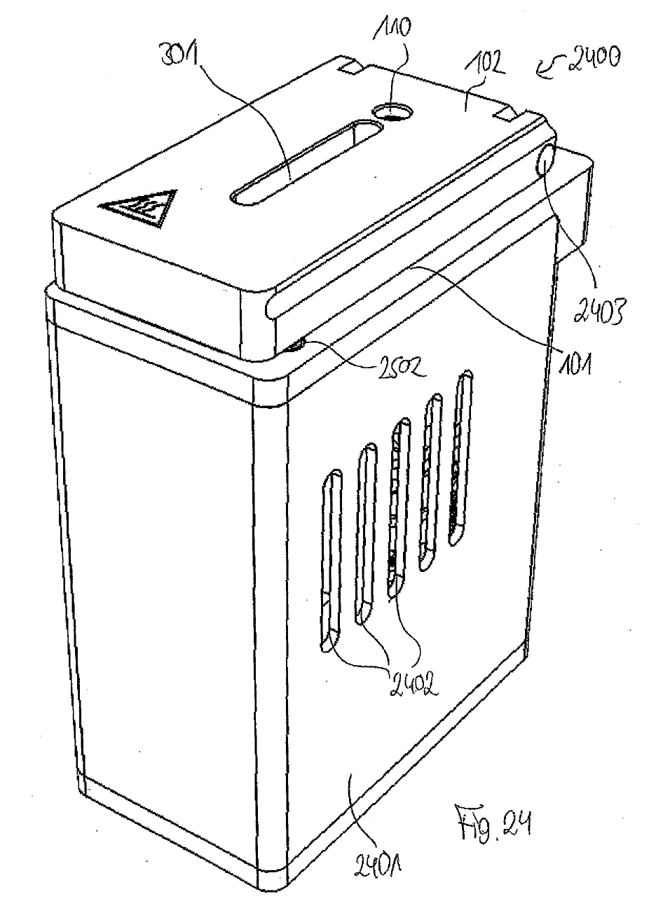

In the following, referring to FIG. 22, a three-dimensional view of a sample handling device 2200 for handling a fluidic sample according to another exemplary embodiment of the invention will be explained.

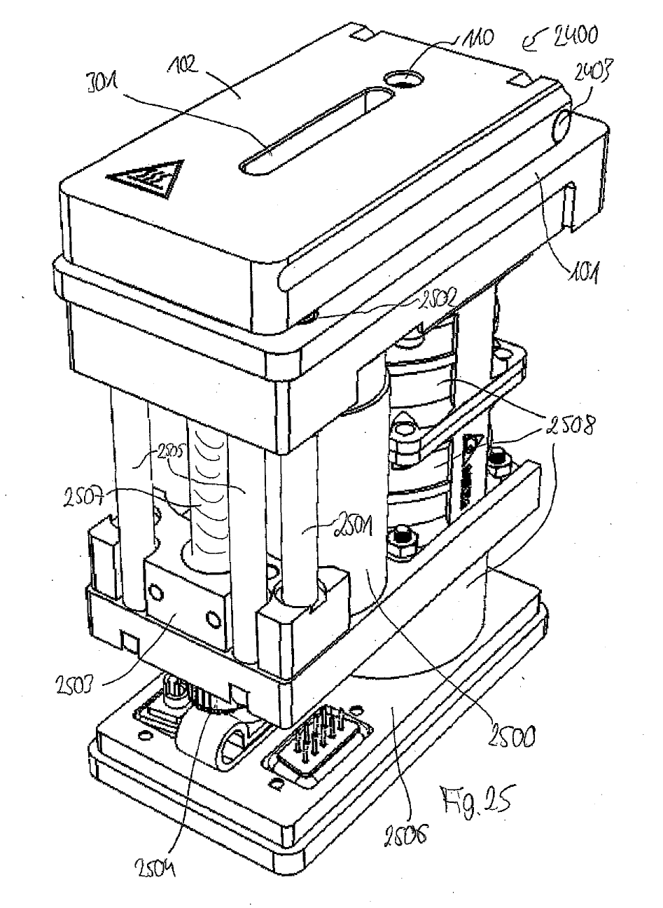

The sample handling device 2200 differs from the sample handling device 200 shown in FIG. 2 particularly in that the housing 201 has four receptions 2201 each for receiving an autarkic module 2400 which will be explained in more detail referring to FIG. 24 to FIG. 27. The embodiment of FIG. 22 allows for the insertion of up to four modules 2400 in the receptions 2201, wherein in the operation mode of FIG. 22, only three modules 2400 are inserted in correspondingly shaped and designed receptions 2201, whereas one of the receptions 2201 is empty. The opportunity to freely insert modules 2400 in or remove modules 2400 from the receptions 2201 allows to flexibly adjust the sample handling device 2400 to user preferences. One of the three modules 2400 is shown in FIG. 22 in an operation state in which the cover element 102 is opened so that the object carrier 125 delimiting the sample space is exposed and thus visible. Two of the three modules 2400 are shown in FIG. 22 in an operation state in which the cover element 102 is closed.

FIG. 23 shows a three-dimensional view of a sample handling device 2300 for handling a fluidic sample according to another exemplary embodiment of the invention.

The sample handling device 2300 differs from the sample handling device 2200 shown in FIG. 22 particularly in that the housing 201 has eight (instead of four) receptions 2201 each for receiving an autarkic module 2400.

FIG. 24 shows a three-dimensional view of a module 2400 (in an assembled operation state) shaped and dimensioned for insertion in a reception 2201 of the housing 201 of any one of the sample handling devices 2200 or 2300.

The module 2400 has a module housing 2401 in which oblong slits 2402 are formed to allow a supply of air for cooling and ventilation purposes. At a hinge 2403, the cover element 102 may be hinged (inserted or installed), or may be unhinged (removed or uninstalled). Thus, the cover element 102 is detachable from the remainder of the module 2400, for instance to make sample supply more convenient or automatic.

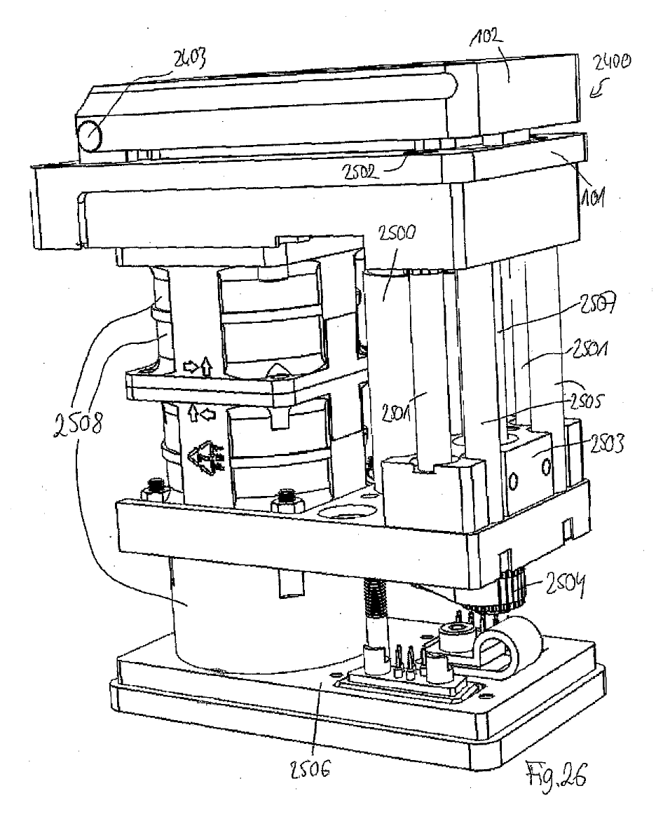

FIG. 25 shows a three-dimensional view of the module 2400 (in a partially disassembled operation state).

As can be taken from FIG. 25, in an interior of the module 2400, a stepper motor 2500 is accommodated. The stepper motor 2500 comprises a spindle drive adapted for driving two pins or shafts 2501 (only one is visible in FIG. 25) for reciprocating so that the pin 2501—when moving upwardly—protrudes through a through hole 2502 formed in the base part 101 and actuates the cover part 102 which follows the motion of the pins or shafts 2501. More particularly, a block 2503 connected to the pins 2501 reciprocates in an upward and in a downward direction.

A gearwheel 2504 serves for transmission of the mechanic force generated by the motor 2500. Spacers 2505 maintain a minimum distance between the block 2503 and a base plate 2506 of the module. A threaded rod 2507 is shown as well.

Furthermore, a turbofan 2508 is shown which may be supplied with surrounding air provided through the slits 2402 for cooling the sample. Such a cooling mechanism may allow to cool the sample from 100° C. to room temperature in 5 minutes or less. Using a heating mechanism (not shown in FIG. 25, but which may be embedded in the base part 101) it may be possible to heat the sample from room temperature to 100° C. in 3 minutes or less.

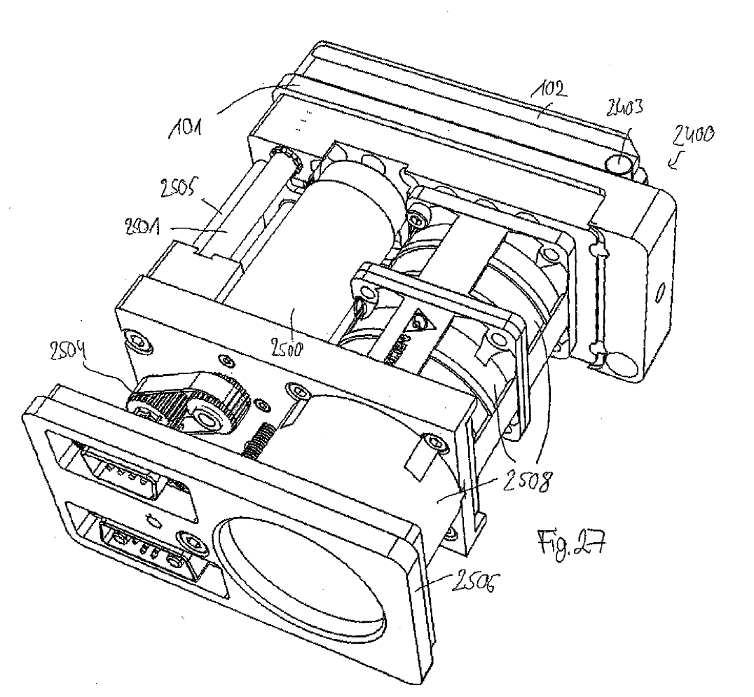

FIG. 26 and FIG. 27 shows other three-dimensional views of the module 2400 (in a partially disassembled operation state).

It should be noted that the term “comprising” does not exclude other elements or features and the “a” or “an” does not exclude a plurality. Also elements described in association with different embodiments may be combined.

It should also be noted that reference signs in the clams shall not be construed as limiting the scope of the claims.

1. A sample handling device for handling a sample, the sample handling device comprising:
a base part;
a cover part;
a first force generating unit adapted to generate a force between the base part and the cover part;
a second force generating unit adapted to generate a counterforce having at least a component being oriented opposite to the force to promote a motion of the base part and the cover part relative to each other;
a control unit adapted for controlling the second force generating unit for moving the base part and the cover part relative to each other for influencing a sample space between the base part and the cover part for accommodating the sample.

2. The sample handling device of claim 1, wherein the first force generating unit is adapted to generate an attracting force promoting attraction between the base part and the cover part.

3. The sample handling device of claim 1, wherein the control unit is adapted for influencing a dimension of the sample space.

4. The sample handling device of claim 1, wherein the base part is provided spatially fixed, and the cover part is provided movably.

5. The sample handling device of claim 1, wherein the base part and the cover part are tiltable with regard to one another.

6. The sample handling device of claim 1, wherein the first force generating unit is adapted to generate an attracting magnetic force.

7. The sample handling device of claim 6, wherein the first force generating unit comprises at least one first magnet arranged at the base part and comprises at least one second magnet arranged at the cover part, the at least one first magnet and the at least one second magnet being adapted to attract each other.

8. The sample handling device of claim 1, wherein the first force generating unit is adapted to generate an attracting biasing force.

9. The sample handling device of claim 1, wherein the first force generating unit is adapted to generate a time-independent force.

10. The sample handling device of claim 1, wherein the second force generating unit is adapted to generate a counterforce to promote an oscillatory motion of the base part and the cover part relative to each other to thereby influence the sample space following the oscillatory motion.

11. The sample handling device of claim 1, wherein the second force generating unit is adapted to generate a counterforce varying in time.

12. The sample handling device of claim 1, wherein the second force generating unit comprises a reciprocating piston adapted for acting on the cover part to promote the motion of the base part and the cover part relative to each other.

13. The sample handling device of claim 12, wherein the reciprocating piston is operable in a first operation state with a first stroke distance (d₁) for supplying the sample to the sample space and is operable in a second operation state with a second stroke distance (d₂) for mixing the sample in the sample space.

14. The sample handling device of claim 13, wherein the first stroke distance (d₁) is larger than the second stroke distance (d₂).

15. The sample handling device of claim 12, comprising a drive unit adapted for pneumatically driving the piston.

16. The sample handling device of claim 1, wherein the second force generating unit comprises a stepper motor, particularly comprising a stepper motor having a spindle drive.

17. The sample handling device of claim 1, comprising a temperature control unit adapted for controlling a temperature of the sample in the sample space.

18. The sample handling device of claim 17, wherein at least a part of the temperature control unit is embedded in the base part.

19. The sample handling device of claim 17, wherein the temperature control unit comprises a ventilating fan.

20. The sample handling device of claim 1, comprising a user interface adapted for enabling a user to control operation of the sample handling device.

21. The sample handling device of claim 20, wherein the user interface is adapted for enabling a user to control at least one of the group consisting of adjusting a sample handling operation mode, starting an analysis, terminating an analysis, and actuating an emergency switch.

22. The sample handling of claim 1, comprising an injection opening provided at the cover part and being in fluid communication with the sample space (130) for supplying the sample to the sample space.

23. The sample handling device of claim 22, comprising a magnetic closure element adapted for magnetically closing the injection opening which comprises a ring magnet, wherein the magnetic closure element and the ring magnet are adapted to attract each other.

24. The sample handling device of claim 1, wherein the cover part is adapted for enabling or disabling access to an injection opening being in fluid communication with the sample space for supplying the sample to the sample space, wherein the enabling or disabling of the access is performable in synchronization with the motion of the base part and the cover part relative to each other.

25. The sample handling device of claim 24, wherein the cover part is adapted for enabling access to the injection opening in an operation state in which the cover part is tilted relative to the base part by an angle of at least a threshold value, and is adapted for disabling access to the injection opening in an operation state in which the cover part is tilted relative to the base part by an angle of less than the threshold value.

26. The sample handling device of claim 1, wherein the cover part is adapted for enabling or disabling access to the sample space in synchronization with the motion of the base part and the cover part relative to each other.

27. The sample handling device of claim 26, wherein the cover part is adapted for enabling access to the sample space in an operation state in which the cover part is tilted relative to the base part by an angle of at least a threshold value, and is adapted for disabling access to the sample space in an operation state in which the cover part is tilted relative to the base part by an angle of less than the threshold value.

28. The sample handling device of claim 1, comprising a tube coupling the injection opening with a sample reservoir for containing the sample.

29. The sample handling device of claim 1, comprising a robot adapted for supplying the sample to the sample space via the injection opening.

30. The sample handling device, wherein the control unit is adapted for synchronizing a sample supply routine according to which the sample is supplied to the sample space and a motion scheme according to which the base part and the cover part are moved relative to each other for influencing the sample space.

31. The sample handling device of claim 1, wherein the cover part is substitutable for adjusting at least one of the group consisting of a size of the sample space, and a number of sample spaces.

32. The sample handling device of claim 1, comprising a ventilation unit adapted for ventilating the sample space.

33. The sample handling device of claim 1, comprising at least one object carrier adapted to be accommodated on the base part and adapted for carrying at least one object under examination to be brought in contact with the sample.

34. The sample handling device of claim 33, wherein the at least one object carrier comprises at least one of the group consisting of a substrate, a plate, a fluidic chip device, and a micro array.

35. The sample handling device of claim 33, wherein the control unit is adapted for substituting the at least one object carrier by another object carrier upon completion of an analysis involving the object carrier and the sample.

36. The sample handling device of claim 1, comprising at least one frame adapted for being inserted in the cover part.

37. The sample handling device of claim 36,
comprising at least one third magnet arranged at the at least one frame,
comprising at least one forth magnet arranged at the cover part,
wherein the at least one third magnet and the at least one forth magnet are adapted to attract each other.

38. The sample handling device of claim 36, comprising at least one insert element adapted for being inserted in the at least one frame.

39. The sample handling device of claim 38, wherein the insert element comprises a flexible seal ring biased for sealing the sample space in an operation state in which the cover part and the base part have a minimum distance from one another.

40. The sample handling device of claim 39, wherein the insert element comprises an essentially planar central plate in which a mechanically reinforcing structure is formed.

41. The sample handling device of claim 40, wherein the mechanically reinforcing structure comprises at least one of the group consisting of a framework structure, a cross structure, a matrix structure, a star structure, and a star structure having a central bump.

42. The sample handling device of claim 38, wherein the insert element comprising an alignment marker adapted for disabling insertion of the insert element in case of an improper orientation of the alignment marker relative to the at least one frame.

43. The sample handling device of claim 1, wherein the base part comprises a guide groove, and wherein the cover part comprises a correspondingly designed guide pin adapted for cooperation with the guide groove.

44. The sample handling device of claim 1, comprising at least one insert element adapted for being inserted in the cover part.

45. The sample handling device of claim 44, wherein the at least one insert element is adapted for being inserted in the cover part by a snap-in mechanism.

46. The sample handling device of claim 24, wherein the injection opening is located essentially at a pivoting axis around which the base part and the cover part are tiltable with regard to one another.

47. The sample handling device of claim 1, adapted as an analysis device for analyzing the sample injected into the sample space, particularly as an analysis device for analyzing the sample based on hybridization events.

48. The sample handling device of claim 1, wherein at least the base part, the cover part, the first force generating unit, and the second force generating unit are adapted as a module for insertion into a reception of a housing of the sample handling device.

49. The sample handling device of claim 48, comprising a housing having a plurality of receptions each adapted for receiving a module.

50. A module for insertion into a reception of a housing of a sample handling device, the module comprising:
a base part;
a cover part;
a first force generating unit adapted to generate a force between the base part and the cover part;
a second force generating unit adapted to generate a counterforce having at least a component being oriented opposite to the force to promote a motion of the base part and the cover part relative to each other;
wherein the second force generating unit is controllable by a control unit for moving the base part and the cover part relative to each other for influencing a sample space between the base part and the cover part for accommodating the sample.

51. A method of handling a sample, the method comprising:
generating a force between a base part and a cover part;
generating a counterforce having at least a component being oriented opposite to the force to promote a motion of the base part and the cover part relative to each other;
controlling the counterforce for moving the base part and the cover part relative to each other for influencing a sample space between the base part and the cover part for accommodating the sample.

52. A program element, which, when being executed by a processor, is adapted to control or carry out a method of claim 51.

53. A computer-readable medium, in which a computer program is stored which, when being executed by a processor, is adapted to control or carry out a method of claim 51.

54. An insert element for insertion into a cover part of a sample handling device for handling a sample, the sample handling device comprising the cover part and a base part for enclosing a sample space for accommodating the sample, wherein the insert element comprises:
an essentially planar central plate defining part of the sample space;
a flexible seal ring surrounding the essentially planar central plate and biased for sealing the sample space.

55. The insert element of claim 54, adapted for insertion into a cover part of a sample handling device of any one of claims 1 to 49.

56. The insert element of claim 54, adapted for insertion into a frame inserted into the cover part of the sample handling device.

57. The insert element claim 54, comprising a ring-like adapter surrounding the flexible seal ring and adapted for insertion into the cover part.

58. The insert element of claim 54, comprising a mechanically reinforcing structure formed on and/or in the essentially planar central plate.

59. The insert element of claim 58, wherein the mechanically reinforcing structure comprises at least one of the group consisting of a framework structure, a cross structure, a matrix structure, a star structure, and a star structure having a central bump.

60. The insert element of claim 54, comprising an alignment marker adapted for disabling insertion of the insert element in case of an improper orientation of the alignment marker relative to the cover part, particularly relative to a frame inserted in the cover part.

61. The insert element of claim 54, adapted for being inserted in the cover part by a snap-in mechanism.

62. The insert element of claim 54, wherein the essentially planar central plate comprises a plurality of protrusions extending vertically from the essentially planar central plate.
